(19) United States
(12) Patent Application Publication
(10) Pub. No.: US 2025/0180042 A1
(43) Pub. Date: Jun. 5, 2025

(54) PROPULSION APPARATUS

(71) Applicant: MOHAMMAD SHAMS, ISFAHAN (IR)

(72) Inventor: MOHAMMAD SHAMS, ISFAHAN (IR)

(21) Appl. No.: 18/969,206

(22) Filed: Dec. 4, 2024

Related U.S. Application Data
(60) Provisional application No. 63/606,228, filed on Dec. 5, 2023.

(51) Int. Cl. F15B 11/08; F15B 13/00

(52) U.S. Cl. CPC F15B 11/08; F15B 13/00

(57) ABSTRACT

In accordance with some embodiments herein, a propulsion apparatus includes a power generation unit, and a propulsion device. The propulsion device includes a rotating assembly and a supporting mechanism which allows the rotating assembly to rotate about one or more rotation axes. The rotating assembly includes two or more pressurizer units, one or more rotating arms connected to the two or more pressurizer units and the supporting mechanism, and one or more transfer pipes connected to the two or more pressurizer units to allow one or more materials to move between the two or more pressurizer units.

### RELATED APPLICATION

This application claims the benefit of U.S. Provisional Patent Application No. 63/606,228, filed Dec. 5, 2023, which is incorporated herein by reference in its entirety.

### TECHNICAL FIELD

The present disclosure relates to mechanical apparatuses, for example, to propulsion apparatuses.

### BACKGROUND

Propulsion apparatuses may be used in various applications, such as transportation, automated robots, etc. A propulsion apparatus may generate force to modify a translational motion of an object.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In some embodiments, a propulsion apparatus is provided. The propulsion apparatus comprises a power generation unit. The propulsion apparatus comprises a propulsion device. The propulsion device comprises a rotating assembly. The rotating assembly comprises two or more pressurizer units. The rotating assembly comprises one or more rotating arms connected to the two or more pressurizer units and a supporting mechanism. The rotating assembly comprises one or more transfer pipes connected to the two or more pressurizer units to allow one or more materials to move between the two or more pressurizer units. The propulsion device comprises the supporting mechanism which allows the rotating assembly to rotate about one or more rotating axes.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a propulsion apparatus generating force which is adjustable in one or more directions, in accordance with some embodiments.

FIG. 2 illustrates a representation of a variation range of forces in a cycle of rotation relative to a rotating mass, in accordance with some embodiments.

FIG. 3 illustrates a chart associated with variation of centrifugal forces in the y-direction and the z-direction relative to a rotating mass in a cycle of rotation, in accordance with some embodiments.

FIG. 4 illustrates a representation of variation of resultant force in a cycle of rotation relative to two opposite rotating masses, in accordance with some embodiments.

FIG. 5 illustrates a chart associated with variation of centrifugal force of two opposite rotating masses in the y-direction and the z-direction, in accordance with some embodiments.

FIG. 6A illustrates a perspective view of a propulsion apparatus, in accordance with some embodiments.

FIG. 6B illustrates a front view of a propulsion apparatus, in accordance with some embodiments.

FIG. 6C illustrates a side view of a propulsion apparatus, in accordance with some embodiments.

FIG. 7 illustrates an example of a rotation of coordinates system based upon a rotation angle, in accordance with some embodiments.

FIG. 8 illustrates a chart associated with variation of masses of two or more cylinders within a propulsion apparatus during a cycle of rotation, in accordance with some embodiments.

FIG. 9 illustrates a chart associated with centrifugal forces of variable masses within two or more cylinders in the y-direction and the z-direction in a cycle of rotation, in accordance with some embodiments.

FIG. 10 illustrates a cross-sectional view of a propulsion apparatus, in accordance with some embodiments.

FIG. 11 illustrates a representation of a fluid splitting method wherein, a fluid splits into a plurality of equal particles, in accordance with some embodiments.

FIG. 12 illustrates a chart associated with forces produced by a fluid within one or more transfer pipes in the y-direction and the z-direction, in accordance with some embodiments.

FIG. 13 illustrates a cross-sectional view of a propulsion apparatus, in accordance with some embodiments.

FIG. 14 illustrates a chart associated with forces produced by a fluid within one or more transfer pipes in the y-direction and the z-direction, in accordance with some embodiments.

FIG. 15 illustrates a cross-sectional view of a propulsion apparatus, in accordance with some embodiments.

FIG. 16 illustrates a chart associated with forces produced by a fluid within one or more transfer pipes in the y-direction and the z-direction, in accordance with some embodiments.

FIG. 17A illustrates a perspective view of a propulsion apparatus in a first state of operation, in accordance with some embodiments.

FIG. 17B illustrates a front view of a propulsion apparatus in a first state of operation, in accordance with some embodiments.

FIG. 17C illustrates a perspective view of a propulsion apparatus in a second state of operation, in accordance with some embodiments.

FIG. 17D illustrates a top view of a propulsion apparatus in a second state of operation, in accordance with some embodiments.

FIG. 17E illustrates a perspective view of a propulsion apparatus in a third state of operation, in accordance with some embodiments.

FIG. 17F illustrates a front view of a propulsion apparatus in a third state of operation, in accordance with some embodiments.

FIG. 17G illustrates a perspective view of a propulsion apparatus in a fourth state of operation, in accordance with some embodiments.

FIG. 17H illustrates a top view of a propulsion apparatus in a fourth state of operation, in accordance with some embodiments.

FIG. 17I illustrates a perspective view of a propulsion apparatus in a fifth state of operation, in accordance with some embodiments.

FIG. 17J illustrates a front view of a propulsion apparatus in a fifth state of operation, in accordance with some embodiments.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

A propulsion apparatus may operate in an environment (e.g., material environment). The environment may comprise particles which create friction and other forces (e.g., thrust, lift and drag forces, etc.) for the propulsion apparatus to work within it. The present disclosure may be used for transferring power to objects in a defined (e.g., specific) and/or adjustable (e.g., controllable) direction and creating movement of the objects without the need for contact between two objects and friction or environment (e.g., atmosphere) can be one of the most important approaches to apply a desired force to a device in different conditions (e.g., gravity, micro gravity, lack of gravity, in the presence of air and in the absence of air, with friction or without friction, etc.).

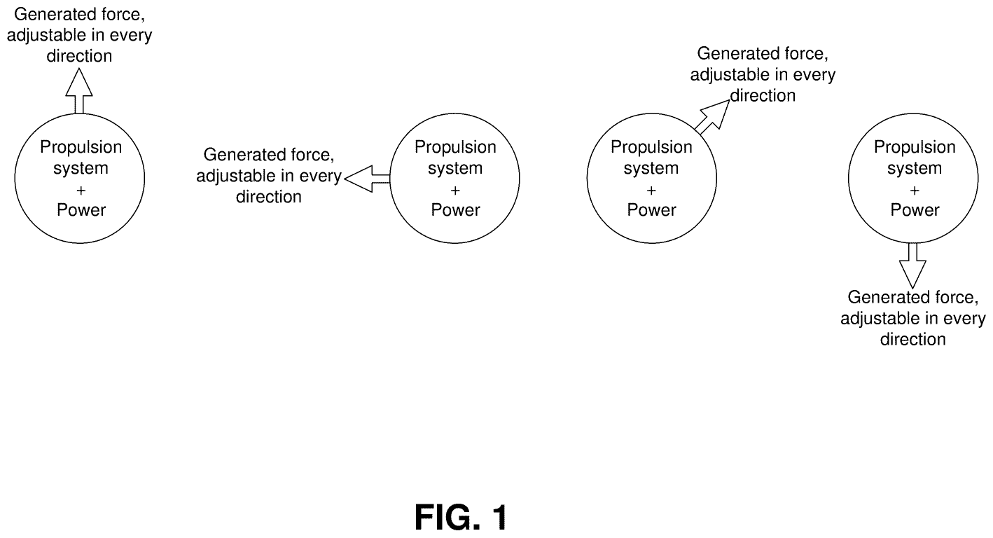

FIG. 1 illustrates a propulsion apparatus, in accordance with some embodiments. In some examples, a force generated by the propulsion apparatus may be adjustable (e.g., controllable) in one or more directions (e.g., every direction). In an example, a generated power provided by a motor (e.g., an electric motor with specified speed and torque) is applied to the propulsion apparatus. In some examples, a generated power provided by a handle (e.g., a handle with specified speed and torque) that may be rotated by a human, is applied to the propulsion apparatus.

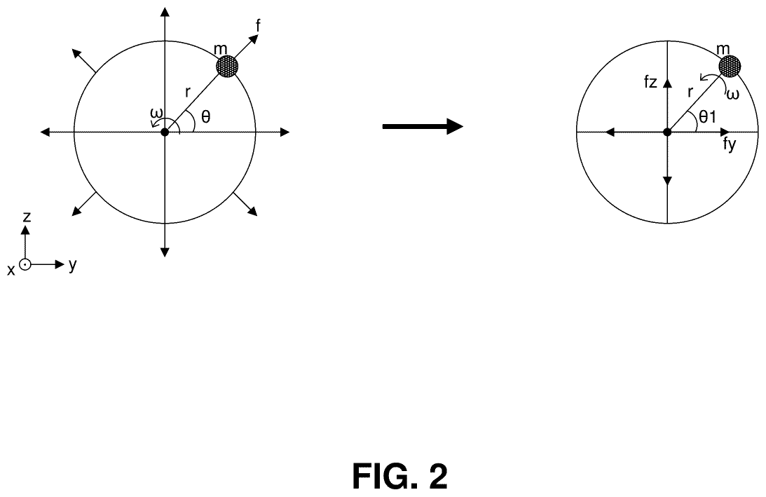

FIG. 2 illustrates a representation of a variation range of forces (e.g., centrifugal forces) in a cycle of rotation relative to a rotating mass, in accordance with some embodiments. In FIG. 2, a resultant force obtained from the rotating mass in a cycle of rotation may be equal to about zero and/or may be determined (e.g., calculated) via below formula:

$$\vec{f} = m \times \vec{ω} \times ( \vec{ω} \times \vec{r} )$$

$$\{ \begin{matrix}{f}_{y} = mr {ω}^{2} cos θ \\ {f}_{z} = mr {ω}^{2} sin θ\end{matrix} ,$$

wherein θ is a radius angle (e.g., an angle between a radius rand the y-direction), and the principle of this propulsion is to concentrate a centrifugal force fin desired directions. A centrifugal force f resulting from rotation of mass m with angular velocity ω (e.g., about the x-axis) at radius r may be equal to f=mrω². The direction of this force may changes between about 0 to about 360 degrees therefore, the resultant force will be equal to about zero.

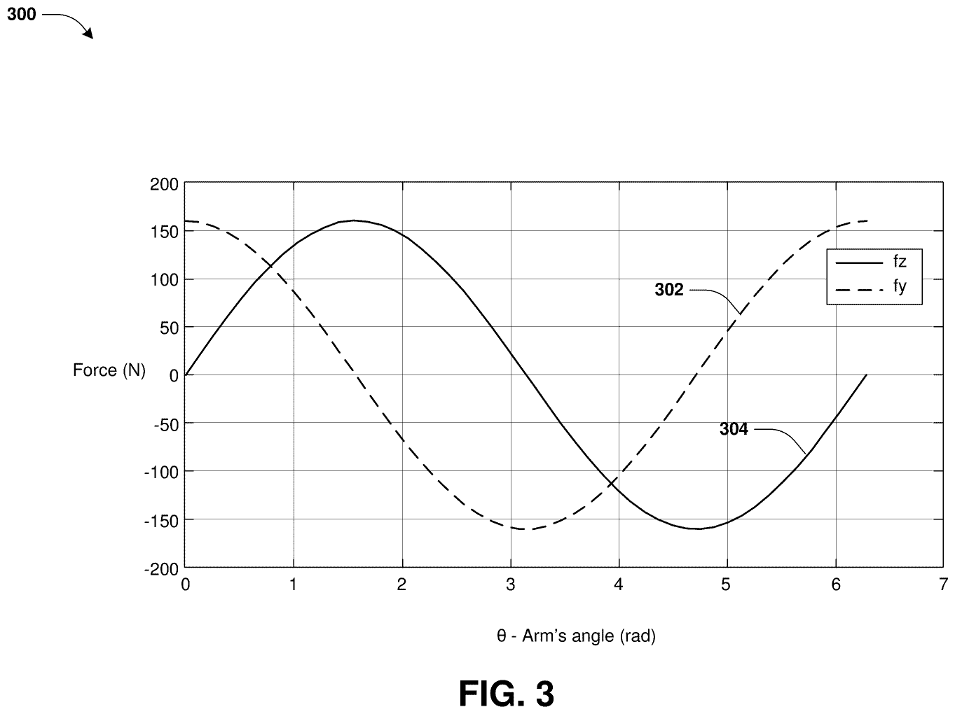

FIG. 3 illustrates an example of variation of centrifugal force in the y-direction and the z-direction. FIG. 3 provides a chart 300 showing curves 302 and 304, which may each correspond to a relationship between force in units of newtons (N) and radius angle θ in units of Radians (rad). The curve 302 may correspond to forces in the y-direction. The curve 304 may correspond to forces in the z-direction. An average centrifugal force in a cycle of rotation may be determined based on radius angle θ and average forces in the z-direction (e.g., the curve 304) and average forces in the y-direction (e.g., the curve 302). The cycle of rotation may be about a full cycle, such as about 2π rad (e.g., 360 degrees). The radius angle θ may change from about 0 rad to about 2π rad (e.g., 0≤θ≤360) and the y-direction average centrifugal force f_{yave} (e.g., about the y-axis) and the z-direction average centrifugal force f_{zave} (e.g., about the z-axis) may be:

$${f}_{zave} = \frac{{\int }_{0}^{2 π} ( mr {ω}^{2} sin θ ) d θ}{2} = 0 , {f}_{yave} = \frac{{\int }_{0}^{2 π} ( mr {ω}^{2} cos θ ) d θ}{2 π} = 0$$

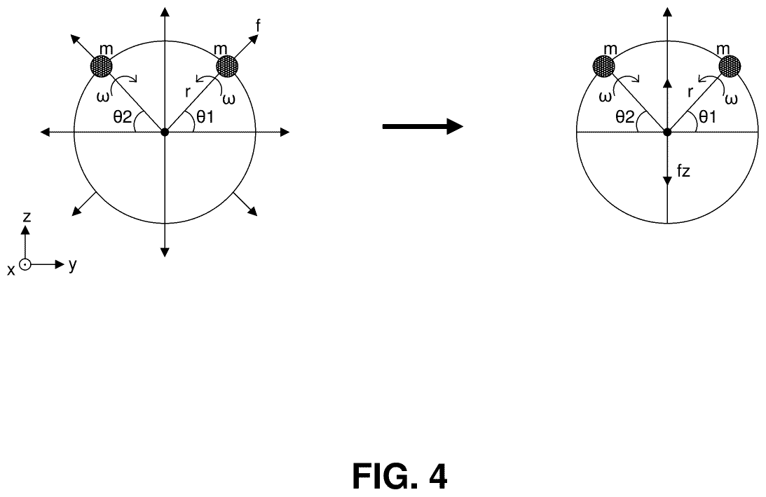

FIG. 4 illustrates an example of two opposite rotating masses and variation of resultant force in a cycle of rotation could be determined as below:

$$\vec{f} = m \times \vec{ω} \times ( \vec{ω} \times \vec{r} ) , \{ \begin{matrix}{f}_{y} = mr {ω}^{2} cos θ \\ {f}_{z} = mr {ω}^{2} sin θ\end{matrix} , \{ \begin{matrix}θ1 = θ \\ sin θ = sin θ1 = sin θ2 \\ cos θ = cos θ1 = - cos θ2\end{matrix}$$

$${F}_{y} = {\sum }_{θ = 0}^{2 π} {f}_{y} ( θ ) = mr {ω}^{2} cos θ1 + mr {ω}^{2} cos θ2 = mr {ω}^{2} cos θ - mr {ω}^{2} cos θ = 0$$

$${F}_{z} = {\sum }_{θ = 0}^{2 π} {f}_{z} ( θ ) = mr {ω}^{2} sin θ1 + mr {ω}^{2} sin θ2 = mr {ω}^{2} sin θ + mr {ω}^{2} sin θ = 2 mr {ω}^{2} sin θ ,$$

in order to eliminate force element in the y-direction, two (or more) opposite rotating masses may be utilized. In some examples, the angular velocity ω and/or the angular acceleration of a first mass (of the two opposite rotating masses) is equal to the angular velocity ω and/or the angular acceleration of a second mass (of the two opposite rotating masses). The first mass is equal to the second mass whereas the rotational direction of the first mass (e.g., clockwise) may be opposite of the rotational direction of the second mass (e.g., counter-clockwise).

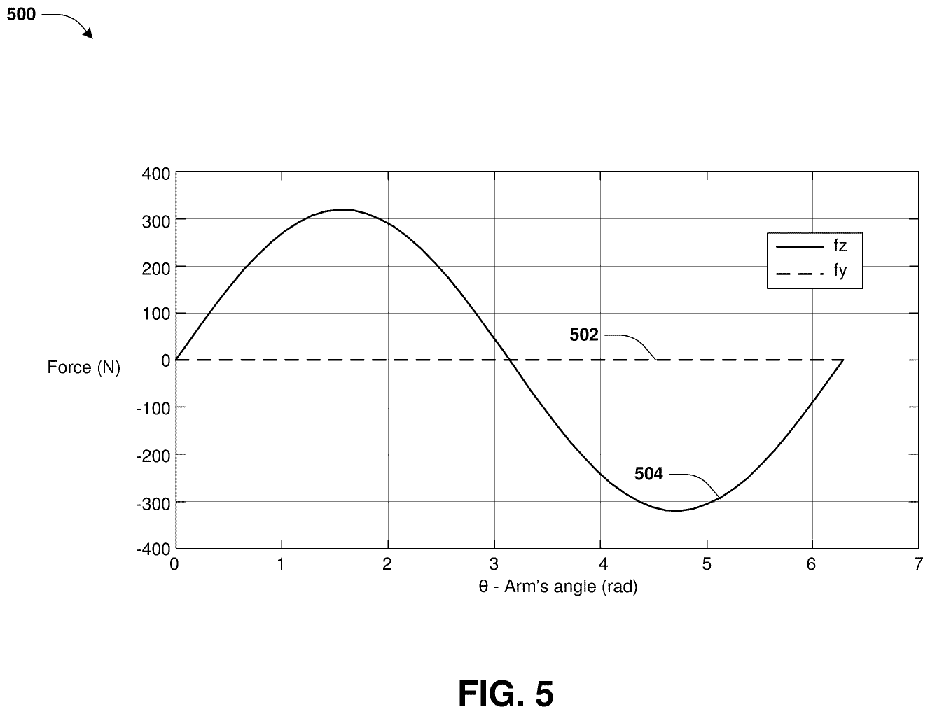

FIG. 5 illustrates an example of variation of centrifugal force of two opposite rotating masses in the y-direction and centrifugal force of two opposite rotating masses in the z-direction. FIG. 5 provides a chart 500 showing curves 502 and 504, which may each correspond to a relationship between force (N) and radius angle θ (rad). The curve 502 may correspond to centrifugal forces in the y-direction. The curve 504 may correspond to centrifugal forces in the z-direction. An average centrifugal force in a cycle of rotation may be determined based on radius angle θ and average forces in the z-direction (e.g., the curve 504) and average forces in the y-direction (e.g., the curve 502). The cycle of rotation may be about a full cycle, such as about 2π rad (e.g., 360 degrees). The radius angle θ may change from about 0 rad to about 2π rad (e.g., 0≤θ≤360) or about π/2 rad to about 5π/2 rad (e.g., 90≤θ≤450) and the z-direction average centrifugal force f_{zave} (e.g., about the z-axis) may be:

$${f}_{zave} = \frac{{\int }_{π / 2}^{5 π / 2} ( 2 mr {ω}^{2} sin θ ) d θ}{2 π} = 0 ,$$

in the mechanisms of FIG. 2 and FIG. 4, the average centrifugal force in a cycle of rotation may be about zero so there may be no extra force to use that for making acceleration and movement in the machine and there may be just vibration.

In accordance with some embodiments of the present disclosure, a propulsion apparatus is provided. The propulsion apparatus, may comprise a power generation unit and a propulsion device. The power generation unit may generate a required power to rotate a rotating assembly. The power generation unit may utilize one or more techniques (e.g., utilizing a manual device and/or an automatic device) to generate the required power to apply to the propulsion device. In an example, the power generation unit utilizes different types of power generation systems such as electric systems, electro-static systems, electromagnetic systems, gravitational systems, eco-friendly power systems (e.g., solar, wind, water, geo-thermal, etc.). The propulsion device may comprise the rotating assembly and a supporting mechanism. The rotating assembly may comprise two or more pressurizer units, one or more rotating arms connected to the two or more pressurizer units and the supporting mechanism, and one or more transfer pipes. The one or more transfer pipes may be connected to the two or more pressurizer units to allow one or more materials to move between the two or more pressurizer units. The supporting mechanism may comprise one or more holding rods, and one or more base plates. The one or more base plates may connect the one or more holding rods to one or more walls of the propulsion device. The supporting mechanism allows the rotating assembly to rotate about one or more rotation axes.

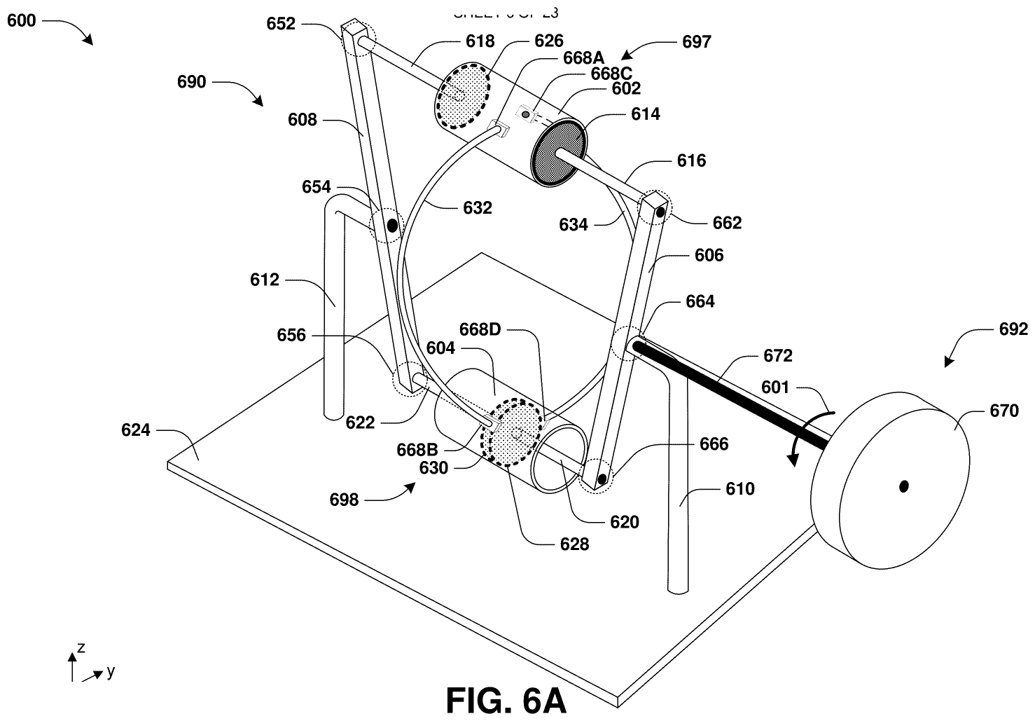

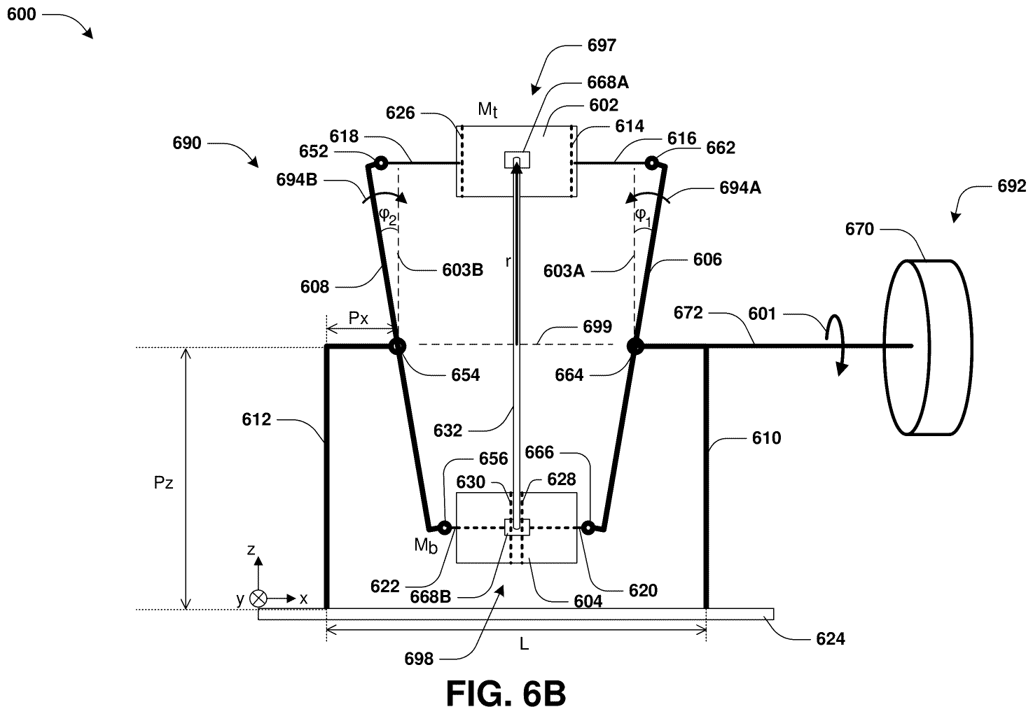

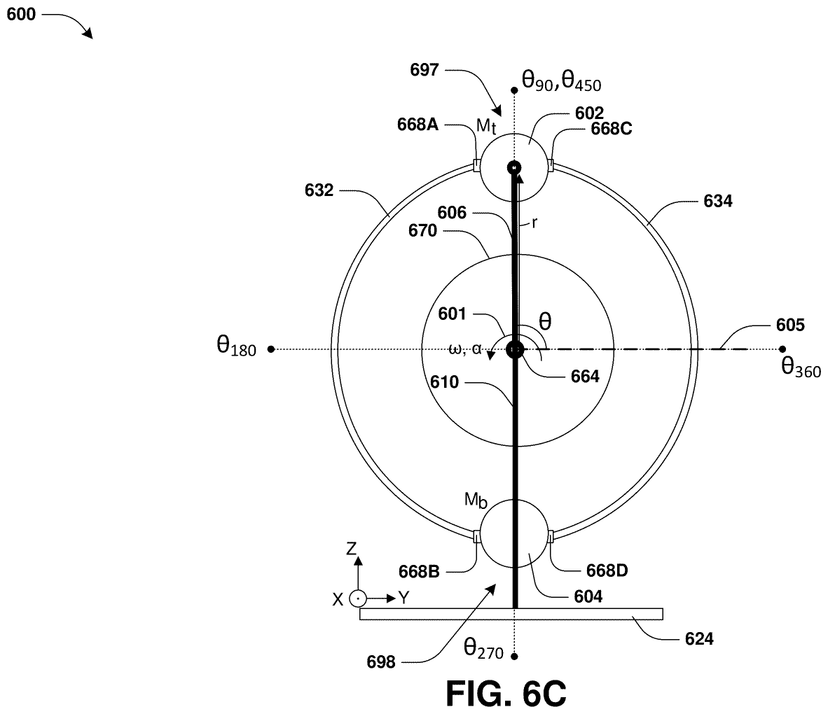

FIG. 6A illustrates a perspective view of a propulsion apparatus, in accordance with some embodiments. FIG. 6B illustrates a front view of a propulsion apparatus, in accordance with some embodiments. FIG. 6C illustrates a side view of a propulsion apparatus, in accordance with some embodiments. As shown in FIG. 6A, the propulsion apparatus 600 may comprise a propulsion device 690 and a power generation unit 692. In some examples, the propulsion device 690 is a non-contacting propulsion device. In some examples, the power generation unit 692 comprises a power generation supplier 670 (e.g., an electric motor) and is connected to the propulsion device 690 via a shaft 672 to provide a required power to rotate a rotation assembly. The propulsion device 690 may comprise the rotating assembly. The rotating assembly may comprise two or more pressurizer units and one or more transfer pipes (e.g., a first transfer pipe 632, a second transfer pipe 634, etc.). In some examples, the two or more pressurizer units may comprise a first pressurizer unit 697 and a second pressurizer unit 698. The two or more pressurizer units and the one or more transfer pipes may be placed on a perimeter of a circle. In some examples, the one or more transfer pipes may be connected to the two or more pressurizer units to allow one or more materials (e.g., a fluid) to move between the two or more pressurizer units. The two or more pressurizer units may comprise two or more cylinders (e.g., a first cylinder 602, a second cylinder 604, etc.) and two or more pistons (e.g., a first piston 614, a second piston 628, a third piston 626, a fourth piston 630, etc.). The first piston 614 may be connected to a first piston connecting rod 616, the second piston 628 may be connected to a second piston connecting rod 620, the third piston 626 may be connected to a third piston connecting rod 618 and the fourth piston 630 may be connected to a fourth piston connecting rod 622. The rotating assembly may comprise one or more joints (e.g., a third joint 662, a fourth joint 666, a fifth joint 652, a sixth joint 656, etc.). The first piston connecting rod 616 may be connected to a first rotating arm 606 via the third joint 662 (e.g., a hinge or a pivot), the second piston connecting rod 620 may be connected to the first rotating arm 606 via the fourth joint 666 (e.g., a hinge or a pivot), the third piston connecting rod 618 may be connected to a second rotating arm 608 via the fifth joint 652 (e.g., a hinge or a pivot), the fourth piston connecting rod 622 may be connected to the second rotating arm 608 via the sixth joint 656 (e.g., a hinge or a pivot). In some examples, two or more pistons move partially inside the two or more cylinders to apply pressure and direct the one or more materials (e.g., a fluid) inside and/or outside the two or more cylinders. In some examples, the one or more materials comprise (e.g., consist of) a fluid (e.g., the one or more materials may be a liquid, a gas, and/or a plasma). In some examples, the one or more materials comprise (e.g., consist of) a solid (e.g., the one or more materials may be one or more balls). In some examples, the one or more materials comprise (e.g., consist of) a combination of the fluid and the solid. In some examples, the two or more pressurizer units comprise various types of cylinders such as single acting cylinders, bellows cylinders, double acting cylinders, multi-stage cylinders and etc. In some examples, the two or more cylinders comprise one or more inlets and one or more outlets connected to the one or more transfer pipes. The direction of the one or more materials may be regulated utilizing one or more valves (e.g., a first valve 668A, a second valve 668B, a third valve 668C, a fourth valve 668D, etc.). The one or more transfer pipes may allow transferring of the one or more materials from the first cylinder 602 of the two or more cylinders to the second cylinder 604 of the two or more cylinders and/or from the second cylinder 604 to the first cylinder 602. In some examples, the propulsion device 690 comprises a supporting mechanism which allows the rotating assembly to rotate about one or more rotation axes. The supporting mechanism may comprise one or more holding rods (e.g., a first holding rod 610, a second holding rod 612, etc.), one or more base plates (e.g., a first base plate 624, etc.), a first joint 664 (e.g., a hinge or a pivot) and a second joint 654 (e.g., a hinge or a pivot). In an example, the first holding rod 610 is connected to the first rotating arm 606 and/or the shaft 672 via the first joint 664. In an example, the second holding rod 612 is connected to the second rotating arm 608 via the second joint 654.

In some examples, the supporting mechanism allows the rotating assembly to rotate about the one or more rotation axes. In an example, the rotation assembly utilizes the first joint 664 and the first holding rod 610 to rotate about one or more rotation axes. For example, the rotation assembly may rotate (using the first joint 664 and the first holding rod 610, for example) in a first rotational direction 601 about the x-axis. As shown in FIG. 6B, the rotation assembly may rotate in the first rotational direction 601 about a line 699 (e.g., a line parallel to the x-axis) and based on the rotation about the line 699, the first rotating arm 606 may rotate about the line 699 with a first angular velocity ω₁ and/or a first angular acceleration α₁ and/or may rotate in a second rotational direction 694A about a second rotation axis (e.g., a line parallel to the y-axis) with second angular velocity ω₂ and/or a second angular acceleration α₂. The second rotating arm 608 may rotate about the line 699 with a first angular velocity ω₁ and/or a first angular acceleration α₁ and/or may rotate in a third rotational direction 694B about a third rotation axis (e.g., a line parallel to the y-axis) with third angular velocity ω₃ and/or a third angular acceleration α₃. In an example, value of the second angular velocity ω₂ is equal to value of the third angular velocity ω₃ and value of the second angular acceleration α₂ is equal to value of the third angular acceleration α₃ while direction of the second angular velocity ω₂ is opposite to direction of the third angular velocity ω₃ and direction of the second angular acceleration α₂ may be opposite to direction of the third angular acceleration α₃. In an example, the power generation supplier 670 utilizes the shaft 672 to allow the rotating assembly to rotate about the line 699 (e.g., a line parallel to the x-axis). In an example, the first rotational direction 601 may be a rotation about the x-axis. In an example, the shaft 672 is connected to the first holding rod 610 and/or the first joint 664. In some examples, the line 699 may be a line between the first joints 664 and the second joint 654.

In one scenario, the rotation of one or more arms may move the two or more pistons inside the two or more cylinders. In an example, the rotation of the first rotating arm 606 applies compression to the first piston 614. The first rotating arm 606 may be connected to the first piston connecting rod 616 via a third joint 662. Alternatively and/or additionally, the rotation of the second rotating arm 608 may apply compression to the third piston 626. The second rotating arm 608 may be connected to the third piston connecting rod 618 via the fifth joint 652. The first piston 614 and the third piston 626 may move partially inside the first cylinder 602 to apply compression and direct the one or more materials via one or more transfer pipes to the second cylinder 604. The applied compression may move the first piston 614 and the third piston 626 towards the geometric center of the first cylinder 602. In an example, the rotation of the first rotating arm 606 applies tension to the second piston 628. The first rotating arm 606 may be connected to the second piston connecting rod 620 via the fourth joint 666. Alternatively and/or additionally, the rotation of the second rotating arm 608 may apply tension to the fourth piston 630. The second rotating arm 608 may be connected to the fourth piston connecting rod 622 via the sixth joint 656. The second piston 628 and the fourth piston 630 may move partially inside the second cylinder 604 to apply tension and receive the one or more materials via one or more transfer pipes from the first cylinder 602. The applied tension may move the second piston 628 and the fourth piston 630 away from the geometric center of the second cylinder 604. The one or more transfer pipes may comprise the one or more valves to allow the one or more materials move between the first cylinder 602 and the second cylinder 604.

In one scenario, the rotation of the first rotating arm 606 applies tension to the first piston 614. Alternatively and/or additionally, the rotation of the second rotating arm 608 may apply tension to the third piston 626. The first piston 614 and the third piston 626 may move partially inside the first cylinder 602 to apply tension and receive the one or more materials via one or more transfer pipes from the second cylinder 604. The applied tension may move the first piston 614 and the third piston 626 away from the geometric center of the first cylinder 602. In an example, the rotation of the first rotating arm 606 applies compression to the second piston 628. Alternatively and/or additionally, the rotation of the second rotating arm 608 may apply compression to the fourth piston 630. The second piston 628 and the fourth piston 630 may move partially inside the second cylinder 604 to apply compression and direct the one or more materials via one or more transfer pipes to the first cylinder 602. The applied compression may move the second piston 628 and the fourth piston 630 towards the geometric center of the second cylinder 604. The one or more transfer pipes may comprise the one or more valves to allow the one or more materials move between the first cylinder 602 and the second cylinder 604.

As shown in FIG. 6C, a first rotation angle θ is an angle between the first rotating arm 606 and a line 605. For example, the first rotating arm 606 may be similar to radius r, and the line 605 may be parallel to the y-axis. In some examples, the first rotation angle θ may be an angle between the radius r and the line 605. The radius r may correspond to a distance from the line 699 to the geometric center of the first cylinder 602 and/or the geometric center of the second cylinder 604. In an example, during a cycle of rotation, the first rotation angle θ changes from about π/2 rad (e.g., 90 degrees) to about 5π/2 rad (e.g., 450 degrees). In an example, during a cycle of rotation, the first rotation angle θ changes from about 0 rad (e.g., 0 degrees) to about 2π rad (e.g., 360 degrees). In an example, the first rotation angle θ is an angle between the second rotating arm 608 and the line 605. The second rotating arm 608 may be the same as (e.g., similar to) the radius r, and the line 605 may be parallel to the y-axis. The first rotation angle θ related to the first rotating arm 606 may be different from the first rotation angle θ related to the second rotating arm 608. In an example, a second rotation angle φ₁ (e.g., with a range from about 45 degrees to about −45 degrees) is an angle between the first rotating arm 606 and a line 603A. A third rotation angle φ₂ (e.g., with a range from about −45 degrees to about 45 degrees) may be an angle between the second rotating arm 608 and a line 603B. Other values of the second rotation angle φ₁ and the third rotation angle φ₂ are within the scope of the present disclosure. In some examples, it is assumed that the line 603A and the line 603B rotate about the x-axis during the rotation of the rotating assembly in the first rotational direction 601 and/or about the x-axis. In an example, the first rotating arm 606 rotates about a first rotation axis (e.g., the first rotational direction 601 about the x-axis) and/or about a second rotation axis (e.g., in the second rotational direction 694A) simultaneously. The second rotating arm 608 may rotate about the first rotation axis (e.g., the first rotational direction 601 about the x-axis) and/or a third rotation axis (e.g., in the third rotational direction 694B) simultaneously. The second rotational direction 694A may change the second rotation angle φ₁ and the third rotational direction 694B may change the third rotation angle φ₂. In an example, a cycle of rotation may comprise four quarters (e.g., a first quarter, a second quarter, a third quarter and/or a fourth quarter). In the first quarter of the cycle of rotation (e.g., θ from about π/2 rad to about π rad (90 ≤θ≤180)) the second rotation angle φ₁ may change from about 45 degrees to about 0 degrees and the third rotation angle φ₂ may change from about −45 degrees to about 0 degrees. In the second quarter of the cycle of rotation (e.g., θ from about π rad to about 3π/2 rad (180≤θ≤270)) the second rotation angle φ₁ may change from about 0 degrees to about −45 degrees and the third rotation angle φ₂ may change from about 0 degrees to about 45 degrees. In the third quarter of the cycle of rotation (e.g., θ from about 3π/2 rad to about 2π rad (270≤θ≤360)) the second rotation angle φ₁ may change from about −45 degrees to about 0 degrees and the third rotation angle φ₂ may change from about 45 degrees to about 0 degrees. In the fourth quarter of the cycle of rotation (e.g., θ from about 2π rad to about 5π/2 rad (360≤θ≤450)) the second rotation angle φ₁ may change from about 0 degrees to about 45 degrees and the third rotation angle φ₂ may change from about 0 degrees to about −45 degrees. In an example, the first quarter may be a rotational direction from a first point θ₉₀ (e.g., a point in which a corresponding value of the first rotation angle θ is about π/2 rad (θ=90 degrees)) to a second point θ₁₈₀ (e.g., a point in which a corresponding value of the first rotation angle θ is about π rad (θ=180 degrees)). In an example, the second quarter may be a rotational direction from the second point θ₁₈₀ to a third point θ₂₇₀ (e.g., a point in which a corresponding value of the first rotation angle θ is about 3π/2 rad (θ=270 degrees)). In an example, the third quarter may be a rotational direction from the third point θ₂₇₀ to a fourth point θ₃₆₀ (e.g., a point in which a corresponding value of the first rotation angle θ is about 2π rad (θ=360 degrees)). In an example, the fourth quarter may be a rotational direction from the fourth point θ₃₆₀ to a fifth point θ₄₅₀ (e.g., a point in which a corresponding value of the first rotation angle θ is about 5π/2 rad (θ=450 degrees)). In an example, the fifth point θ₄₅₀ may coincident with the first point θ₉₀.

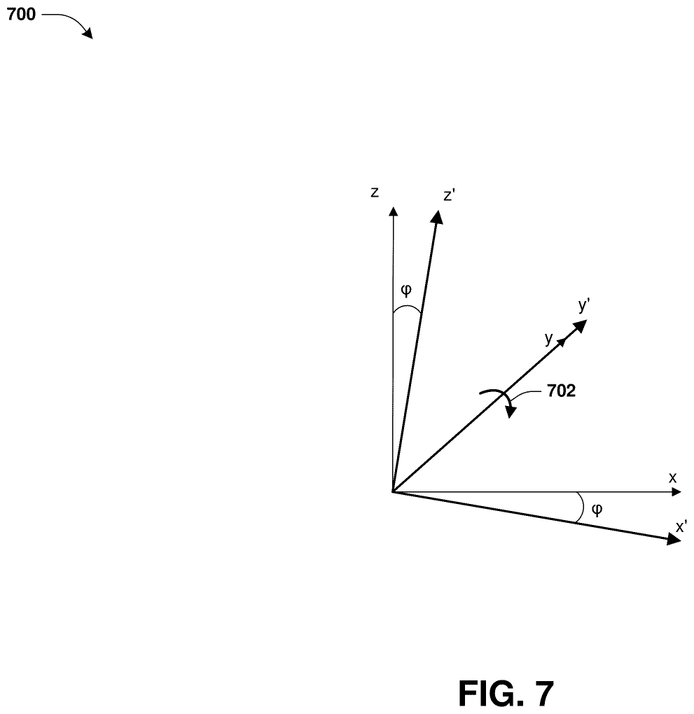

FIG. 7 illustrates an example 700 of a rotation of coordinate system based upon a rotation angle, in accordance with some embodiments. FIG. 7 illustrates an example of rotation. In some examples, the rotation may be a rotation of one or more rotating arms about y-axis. In FIG. 7, rotation of one or more rotating arms (e.g., the first rotating arm 606, the second rotating arm 608, etc.) may be displayed on the y′z′-plane of the x′y′z′ coordination system. As shown in FIG. 7, the x′y′z′ coordination system may be generated via a rotation 702 of the xyz coordination system about the y-axis by a degree represented by “φ”. Rotation angle of one or more rotating arms may be determined based on the y′z′-plane of the x′y′z′ coordination system relative to the y′-axis and is being represented by “θ”. In an example, the direction of the rotation of the one or more rotating arms is determined based upon the right-hand rule. In some examples, angular velocity of one or more rotating arms is measured (e.g., in Radians per second (rad/sec)) and is being represented by “w”. In addition, angular acceleration of the one or more rotating arms is being represented by “a”.

In an example, rotation matrix about the y-axis by φ degree is determined as follows:

$${R}_{{y}^{′}} ( ϕ ) = [ \begin{matrix}cos ( ϕ ) & 0 & sin ( ϕ ) \\ 0 & 1 & 0 \\ - sin ( ϕ ) & 0 & cos ( ϕ )\end{matrix} ]$$

$$[ \begin{matrix}x \\ y \\ z\end{matrix} ] = {R}_{{y}^{′}} ( ϕ ) [ \begin{matrix}{x}^{′} \\ {y}^{′} \\ {z}^{′}\end{matrix} ] = [ \begin{matrix}cos ( ϕ ) & 0 & sin ( ϕ ) \\ 0 & 1 & 0 \\ - sin ( ϕ ) & 0 & cos ( ϕ )\end{matrix} ] [ \begin{matrix}{x}^{′} \\ {y}^{′} \\ {z}^{′}\end{matrix} ] ,$$

a first rotating arm of the one or more rotating arms rotates on the y′z′ plane and the image of the first rotating arm in the x′y′z′ coordinate system may be as follows:

$$t side Arm : \{ \begin{matrix}{{x}^{′}}_{t} = 0 \\ {{y}^{′}}_{t} = r cos θ \\ {{z}^{′}}_{t} = r sin θ\end{matrix}$$

$$b side Arm : \{ \begin{matrix}{{x}^{′}}_{b} = 0 \\ {{y}^{′}}_{b} = r cos ( θ + π ) \\ {{z}^{′}}_{b} = r sin ( θ + π )\end{matrix} ,$$

wherein the t side Arm is a first portion (e.g., top portion) of the first rotating arm and the b side Arm is a second portion (e.g., bottom portion) of the first rotating arm. In an example, e is a first rotation angle. In an example, the quantity of the first rotation angle θ changes when the first rotating arm rotates about the x-axis.

Image of the first rotating arm of the one or more rotating arms in the xyz coordination system may be determined as follows:

$$[ \begin{matrix}{x}_{t} \\ {y}_{t} \\ {z}_{t}\end{matrix} ] = [ \begin{matrix}cos ( ϕ ) & 0 & sin ( ϕ ) \\ 0 & 1 & 0 \\ - sin ( ϕ ) & 0 & cos ( ϕ )\end{matrix} ] [ \begin{matrix}0 \\ r cos θ \\ r sin θ\end{matrix} ] = [ \begin{matrix}\begin{matrix}r sin θ \times sin ϕ \\ r cos θ\end{matrix} \\ r sin θ \times cos ϕ\end{matrix} ]$$

$$t side : \{ \begin{matrix}{x}_{t} = r Sin θ \times Sin ϕ \\ {y}_{t} = r Cos θ \\ {z}_{t} = r sin θ \times Cos ϕ\end{matrix} , \{ \frac{π}{2} \leq θ \leq \frac{5 π}{2}$$

$$b side : \{ \begin{matrix}{x}_{b} = r Sin ( θ + π ) \times Sin ϕ \\ {y}_{t} = r Cos ( θ + π ) \\ {z}_{t} = r sin ( θ + π ) \times Cos ϕ\end{matrix} , \{ \frac{π}{2} \leq θ \leq \frac{5 π}{2} ,$$

wherein the t side Arm is a first portion (e.g., top portion) of the first rotating arm and the b side Arm is a second portion (e.g., bottom portion) of the first rotating arm. In an example, θ is a first rotation angle, and the quantity of θ changes during the rotation about the x-axis and φ is a second rotation angle (e.g., an angle between the z-axis and the z′-axis or an angle between the x-axis and the x′-axis) about a second rotation axis (e.g., the y-axis).

At any given moment, the opening length of the cylinders may be equivalent to the space between the first rotating arm and the second rotating arm at the connection points with the cylinders. Distance between the first rotating arm and a second rotating arm of the one or more rotating arms in each first rotation angle θ is as follows:

$${Armdis}_{t} = ( L - 2 {P}_{x} ) - 2 pisrod + 2 {x}_{t}$$

$${Armdis}_{b} = ( L - 2 {P}_{x} ) - 2 pisrod + 2 {x}_{b}$$

wherein Armdisₜ may refer to distance between the third joint 662 and the fifth joint 652 minus the length of the first piston connecting rod 616 and minus the length of the third piston connecting rod 618. Armdis_{b} may refer to distance between the fourth joint 666 and the sixth joint 656 minus the length of the second piston connecting rod 620 and minus the length of the fourth piston connecting rod 622. In addition, Pₓ may refer to the distance between the line 603B and the second holding rod 612, and L may refer to the distance between the first holding rod 610 and the second holding rod 612. In addition, L−2Pₓ may refer to distance between a first joint 664 and the second joint 654, and 2pisrod may refer to length of the first piston connecting rod 616 and the third piston connecting rod 618.

In an example, the acceleration obtained from rotating of the fluid (discussed herein with respect to FIGS. 6A-6C) inside the two or more cylinders (e.g., the first cylinder 602 and/or the second cylinder 604) may be determined as follows:

$${A}_{zt} = - r {ω}^{2} cos θ$$

$${A}_{yt} = - r {ω}^{2} sin θ$$

$${A}_{zb} = - r {ω}^{2} cos ( θ + π )$$

$${A}_{yb} = - r {ω}^{2} sin ( θ + π ) ,$$

wherein, the fluid is assumed to rotate about the x-axis with constant angular velocity ω, and the rotation angle θ (e.g., ranged from about 0 rad to about 2π rad (e.g., 0≤θ≤360)). During the rotation of the one or more rotating arms, mass of the first cylinder and mass of the second cylinder 604 are assumed to change within a range of minimum and maximum value, and/or wherein A_{zt} represents acceleration of the fluid inside the first cylinder 602 in the z-direction with unit of measure

$$( e . g . , ( \frac{meters ( m )}{{( seconds ( s ) )}^{2}} ) )$$

and A_{yt} represents acceleration of the fluid inside the first cylinder 602 in the y-direction with unit of measure (e.g.,

$$( \frac{m}{{s}^{2}} ) ) .$$

Alternatively and/or additionally, A_{zb} represents acceleration of the fluid inside the second cylinder 604 in the z-direction with unit of measure (e.g.,

$$( \frac{m}{{s}^{2}} ) )$$

and A_{yb} represents acceleration of the fluid inside the second cylinder 604 in the y-direction with unit of measure (e.g.,

$$( \frac{m}{{s}^{2}} ) ) .$$

In some examples, mass of the fluid inside the first cylinder 602 and the second cylinder 604 is determined as below:

$${M}_{t} = ρ \times ( \frac{π}{4} {d}_{c}^{2} ) \times {Armdis}_{t}$$

$${M}_{b} = ρ \times ( \frac{π}{4} {d}_{c}^{2} ) \times {Armdis}_{b} ,$$

wherein Mₜ represents mass of the fluid inside the first cylinder 602 and M_{b} represents mass of the fluid inside the second cylinder 604. Alternatively and/or additionally, ρ represents density of the fluid inside the first cylinder 602 and the second cylinder 604, and d_{c} represents diameter of the first cylinder 602 and the second cylinder 604.

In an example, disregarding a force generated by one or more transfer pipes, the force obtained from rotating of the fluid is determined as follows:

$${f}_{z} = - ( {M}_{t} \times {A}_{zt} + {M}_{b} \times {A}_{zb} )$$

$${f}_{y} = - ( {M}_{t} \times {A}_{yt} + {M}_{b} \times {A}_{yb} ) ,$$

wherein f_{z} represents force obtained from rotating of the fluid about the z-direction with unit of measure (e.g., N) and f_{y} represents force obtained from rotating of the fluid about the y-direction with unit of measure (e.g., N).

In some examples, the radius r is between about 10 millimeters (mm) to about 2000 mm (and/or between about 10 mm to about 1000 mm). For example, the radius r may be about 100 mm. Other values of the radius r, are within the scope of the present disclosure. In some examples, the second rotation angle φ is between about −45 to about 45 degrees (and/or between about −10 to about 10). For example, the second rotation angle φ may be about 10 degrees. Other values of the second rotation angle φ, are within the scope of the present disclosure. In some examples, the angular velocity ω is between about 1 rad/s to about 10000 rad/s (and/or about 10 rad/s to about 1000 rad/s). For example, the angular velocity ω may be about 100 rad/s. Other values of the angular velocity ω, are within the scope of the present disclosure. In some examples, the diameter d_{c} of the first cylinder 602 and the second cylinder 604 may be between about 5 mm to about 100 mm (and/or between about 10 mm to about 50 mm). For example, the diameter d_{c} may be about 20 mm. Other values of the diameter do, of the first cylinder 602 and the second cylinder 604 are within the scope of the present disclosure. In some examples, the density ρ of the fluid is between about 100 Kilograms (kg)/(meters (m))₃ to about 20000 kg/m³ (and/or between about 200 kg/m³ to about 15000 kg/m³). For example, the density of the fluid may be about 13500 kg/m³. Other values of the density ρ, are within the scope of the present disclosure. In some examples, the z-direction force f_{z} (e.g., the force obtained from rotating of the fluid about the z-axis) and the y-direction force f_{y} (e.g., the force obtained from rotating of the fluid about the y-axis) may be determined accordingly.

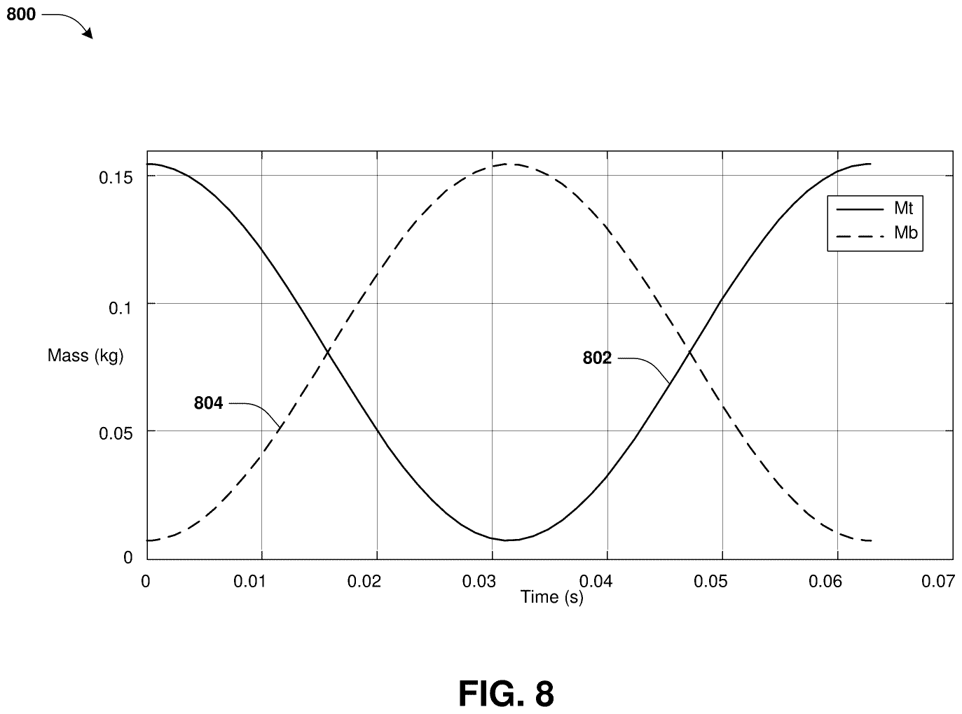

FIG. 8 illustrates a chart 800 associated with variation of masses of two or more cylinders within a propulsion apparatus during a cycle of rotation, in accordance with some embodiments. The chart 800 comprises a first instantaneous mass curve 802 representative of instantaneous mass of the fluid (discussed herein with respect to FIGS. 6A-6C) inside the first cylinder 602. The chart 800 comprises a second instantaneous mass curve 804 representative of instantaneous mass of the fluid inside the second cylinder 604. In some examples, the first instantaneous mass curve 802 and the second instantaneous mass curve 804 are measured during a time period (e.g., a duration of about 0.07 seconds shown in the chart 800 of FIG. 8). The chart 800 illustrates instantaneous changes in mass of the fluid during a cycle of rotation (e.g., 2π rad (e.g., 360 degrees)). In some examples, at the beginning of a first quarter of a cycle of rotation, the amount of the first instantaneous mass curve 802 is maximum (e.g., about 0.1618 kg) and the amount of the second instantaneous mass curve 804 is minimum (e.g., about 0 kg). The average mass of the fluid inside the first cylinder 602 and the average mass of the fluid inside the second cylinder 604 may be determined as follows:

$${M}_{{t}_{ave}} = {M}_{{b}_{ave}} = \frac{\int {M}_{b} \times {d}_{t}}{{Δ}_{t}} = 0.0809 kg ,$$

wherein Mₜ_{ₐᵥₑ} is the average mass of the fluid inside the first cylinder 602 in a cycle of rotation and M_{b}_{ₐᵥₑ} is the average mass of the fluid inside the second cylinder 604 in a cycle of rotation. The total mass of the fluid inside the first cylinder 602 and the second cylinder 604 may be determined as follows:

$${M}_{total} = {M}_{t} + {M}_{b} = 0.1618 kg ,$$

wherein Mₜₒₜₐₗ is the summation of the first instantaneous mass curve 802 and the second instantaneous mass curve 804 at each time of a cycle of rotation which remains constant at each time of a cycle of rotation.

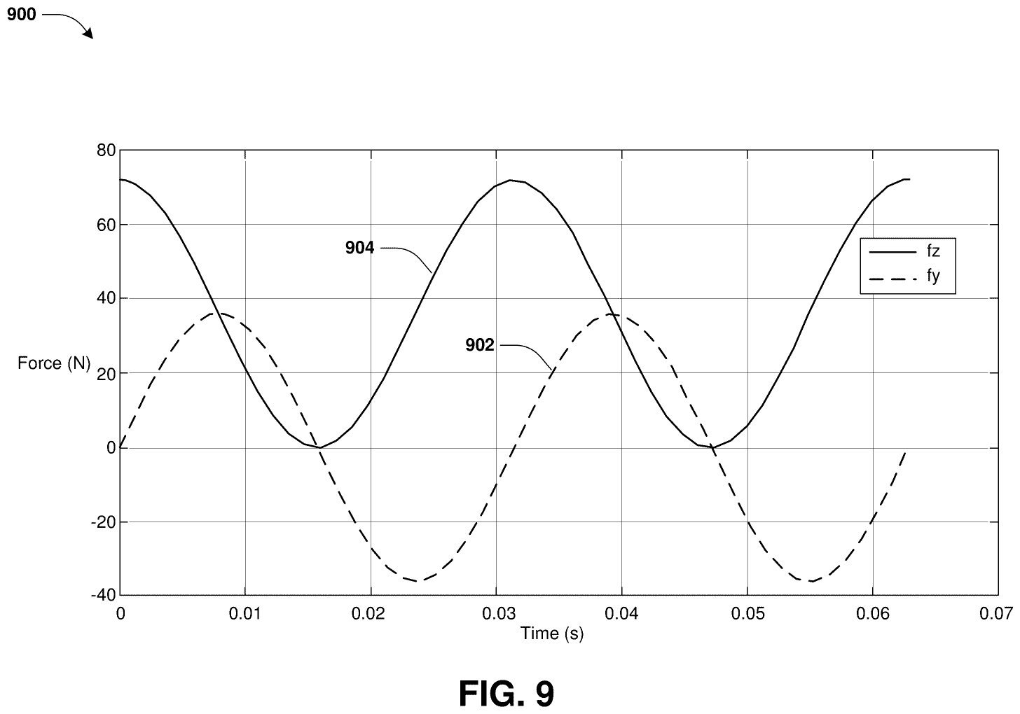

FIG. 9 illustrates a chart 900 associated with centrifugal forces of variable masses within two or more cylinders in the y-direction and the z-direction in a cycle of rotation, in accordance with some embodiments. The chart 900 comprises a first centrifugal force curve 902 representative of a y-direction centrifugal force of the fluid (discussed herein with respect to FIGS. 6A-6C) inside the two or more cylinders relative to the y-direction. The chart 900 comprises a second centrifugal force curve 904 representative of a z-direction centrifugal force of the fluid inside the two or more cylinders relative to the z-direction. In some examples, the centrifugal force (in the y-direction and/or the z-direction, for example) depicted by the first centrifugal force curve 902 and/or the second centrifugal force curve 904 may be produced when the rotating assembly performs a cycle of rotation in a time period (e.g., a duration of about 0.07 seconds shown in the chart 900 of FIG. 9). In an example, the y-direction average force f_{y}_{ₐᵥₑ} of the fluid (e.g., about the y-axis) on the first base plate 624 and the z-direction average force f_{z}_{ₐᵥₑ} of the fluid (e.g., about the z-axis) on the first base plate 624 in a cycle of rotation are determined as follows:

$${f}_{{y}_{ave}} = \frac{\int {f}_{y} \times {d}_{t}}{{Δ}_{t}} = 0.002 N$$

$${f}_{{z}_{ave}} = \frac{\int {f}_{z} \times {d}_{t}}{{Δ}_{t}} = 35.95 N$$

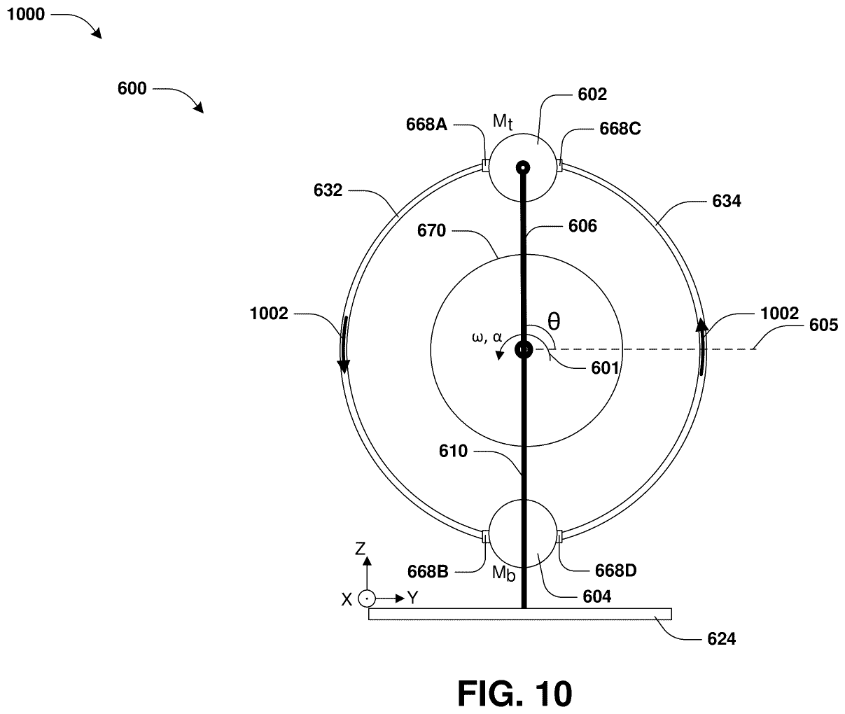

FIG. 10 illustrates a scenario 1000 associated with the propulsion apparatus 600 (shown with a cross-sectional view), in accordance with some embodiments. In FIG. 10, the propulsion apparatus 600 comprises the fluid (discussed herein with respect to FIGS. 6A-6C). Direction of a rotation 1002 of the fluid inside the one or more transfer pipes may be the same as (and/or similar to) direction of the first rotational direction 601 about the x-axis. In some examples, regarding to position of the one or more rotating arms at every moment during a cycle of rotation as the rotating assembly rotates, the first transfer pipe 632 of the one or more transfer pipes may have the fluid flow (e.g., with the direction of a rotation 1002 of the fluid). In some examples, regarding to position of the one or more rotating arms at every moment as the rotating assembly rotates, the second transfer pipe 634 of the one or more transfer pipes may have the fluid flow (e.g., with the direction of a rotation 1002 of the fluid). In some examples, in the propulsion apparatus 600, when the first piston 614 and the third piston 626 move towards the geometric center of the first cylinder 602, the second piston 628 and the fourth piston 630 move away from the geometric center of the second cylinder 604. According to the movement of the two or more pistons, the first valve 668A may allow the fluid inside the first cylinder 602 to enter the first transfer pipe 632, and the second valve 668B may allow the fluid inside the first transfer pipe 632 to enter the second cylinder 604. In some examples, when the second piston 628 and the fourth piston 630 move towards the geometric center of the second cylinder 604, the first piston 614 and the third piston 626 move away from the geometric center of the first cylinder 602. According to the movement of the two or more pistons, the fourth valve 668D may allow the fluid inside the second cylinder 604 to enter the second transfer pipe 634, and the third valve 668C may allow the fluid inside the second transfer pipe 634 to enter the first cylinder 602.

In some examples, absolute angular velocity ω_{abs} of the fluid equals the angular velocity ω of the one or more transfer pipes plus the relative angular velocity ωᵣ of the fluid inside the one or more transfer pipes. Alternatively and/or additionally, absolute angular acceleration α_{abs} of the fluid equals the angular acceleration α of the one or more transfer pipes plus the relative angular acceleration αᵣ of the fluid inside the one or more transfer pipes. The absolute angular velocity ω_{abs} and the absolute angular acceleration α_{abs} of the fluid may be determined as follows:

$${ω}_{a b s} = ω + {ω}_{r}$$

$${α}_{a b s} = α + {α}_{r}$$

In an example, when there is no fluid flow (and/or less than a threshold amount of fluid flow) inside the one or more transfer pipes (e.g., the valves prevent the fluid from flowing through the one or more transfer pipes), the value of the relative angular velocity ωᵣ and the relative angular acceleration αᵣ of the fluid may be about zero therefore, the absolute angular velocity ω_{abs} and the absolute angular acceleration α_{abs} of the fluid may be determined as follows:

ω_{abs}=ω

α_{abs}=α

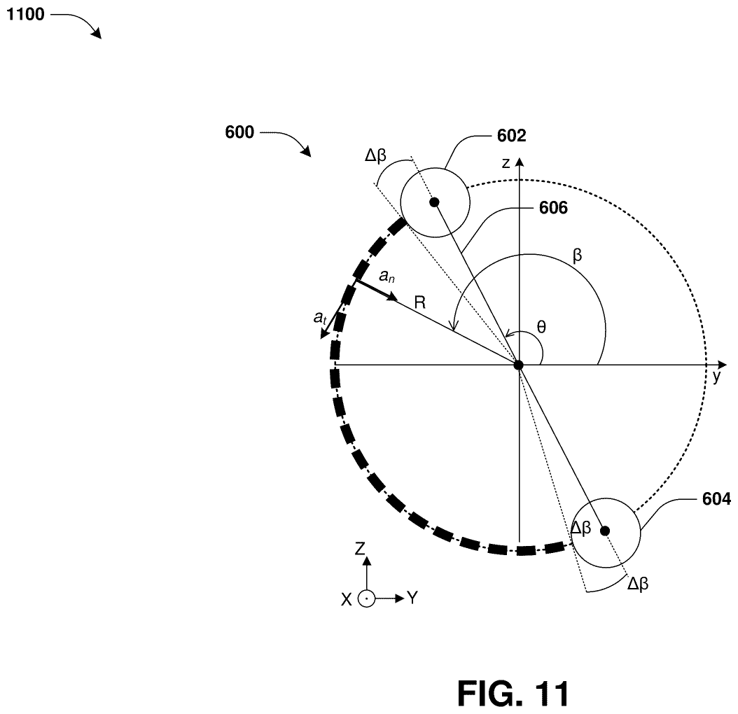

FIG. 11 illustrates a scenario 1100 associated with the propulsion apparatus 600, in accordance with some embodiments. In FIG. 11, a representation of a fluid splitting method is shown. In some examples, a fluid splits into a plurality of equal particles. The fluid (discussed herein with respect to FIGS. 6A-6C) inside the one or more transfer pipes may be divided into a plurality of equal parts (e.g., a plurality of equal particles) with equal masses. In some examples, acceleration and force of each particle of the plurality of equal particles are measured and furthermore, the resultant force of the fluid are obtained via summing up the force of each particle of the plurality of equal particles. Tangential acceleration aₜ and normal acceleration aₙ of each particle of the plurality of equal particles may be determined as follows:

$$\frac{π}{2} ≪ θ ≪ \frac{5 π}{2}$$

$$for each θ : \{ \begin{matrix}β 1 = ( θ + Δ β ) \\ β 2 = ( θ + π − Δ β ) \\ β 1 ≪ β ≪ β 2\end{matrix}$$

$${\vec{a}}_{t} = {\vec{α}}_{a b s} \times \vec{R}$$

$${\vec{a}}_{n} = {\vec{ω}}_{a b s} \times ( {\vec{ω}}_{a b s} \times \vec{R} )$$

$${a}_{t} : 〈 \begin{matrix}{a}_{t z} = R {α}_{a b s} cos β \\ {a}_{t y} = − R {α}_{a b s} sin β\end{matrix}$$

$${a}_{n} : 〈 \begin{matrix}{a}_{n z} = − R {ω}_{a b s}^{2} sin β \\ {a}_{n y} = − R {ω}_{a b s}^{2} cos β ,\end{matrix}$$

wherein β represents an angle between the y-direction of the xyz coordination system and radius R. The radius R represents the distance from center of each particle of the plurality of equal particles to the center of the xyz coordination system.

In some examples, total mass M of the fluid inside the one or more transfer pipes and mass of each particle m of the plurality of equal particles are determined as follows:

$$M = ρ ( \frac{π \times {d}_{p}^{2}}{4} ) \times R ( π - 2 \times Δβ )$$

$$m = \frac{M}{n} ,$$

wherein n represents a quantity of particles of the plurality of equal particles, and dₚ represents diameter of the one or more transfer pipes.

Embodiments are contemplated in which the plurality of equal parts are not equal to each other and/or do not have the same properties (e.g., mass, volume, etc.) as each other. Embodiments are contemplated in which the plurality of equal particles are not equal to each other and/or do not have the same properties (e.g., mass, volume, etc.) as each other. Embodiments are contemplated in which the plurality of equal parts are about equal to each other and/or have about the same properties (e.g., mass, volume, etc.) as each other. Embodiments are contemplated in which the plurality of equal particles are about equal to each other and/or have about the same properties (e.g., mass, volume, etc.) as each other.

In an example, the force of each particle of the plurality of equal particles acts in the opposite direction to the force exerted on the one or more base plates (e.g., the first base plate 624), so it may be multiplied by −1. In some examples, the force of each particle of the plurality of equal particles exerted on the one or more base plates in the z-direction and the force of each particle of the plurality of equal particles exerted on the one or more base plates in the y-direction is determined as follows:

$${f}_{z} = {\sum }_{β = β 1}^{β 2} - m \times ( {{a}_{tz}}_{β} + {a}_{n {z}_{β}} ) = {\sum }_{β = β 1}^{β 2} - m \times ( R {α}_{a b s} cos β - R {ω}_{a b s}^{2} sin β )$$

$${f}_{y} = {\sum }_{β = β 1}^{β 2} - m \times ( {{a}_{ty}}_{β} + {{a}_{ny}}_{β} ) = {\sum }_{β = β 1}^{β 2} - m \times ( - R {α}_{a b s} sin β - R {ω}_{a b s}^{2} cos β )$$

In an example, the y-direction total force f̅_{z} and the z-direction total force f̅_{y} obtained from rotating the plurality of equal particles inside the one or more transfer pipes are determined in the entire range of the first rotation angle θ (e.g., from about π/2 rad to about 5π/2 rad (e.g., 90<θ<450)) as follows:

$$\overline{{f}_{z}} = [ f {1}_{z} f {2}_{z} f {3}_{z} … {fp}_{z} ]$$

$$\overline{{f}_{y}} = [ f {1}_{y} f {2}_{y} f {3}_{y} … {fp}_{y} ]$$

wherein θ is divided into p parts (e.g., with number from about 1 to about p). Wherein for example, f1_{z} is a z-direction resultant force in θ1 (e.g. about π/2 rad) of the plurality of equal particles (e.g., all particles) inside the one or more transfer pipes, and fp_{z} is a z-direction resultant force in θp (e.g. about 5π/2 rad) of the plurality of equal particles (e.g., all particles) inside the one or more transfer pipes. Wherein for example, f1_{y} is a y-direction resultant force in θ1 (e.g. about π/2 rad) the plurality of equal particles (e.g., all particles) inside the one or more transfer pipes, and fp_{y} is a y-direction resultant force in θp (e.g. about 5π/2 rad) of the plurality of equal particles (e.g., all particles) inside the one or more transfer pipes.

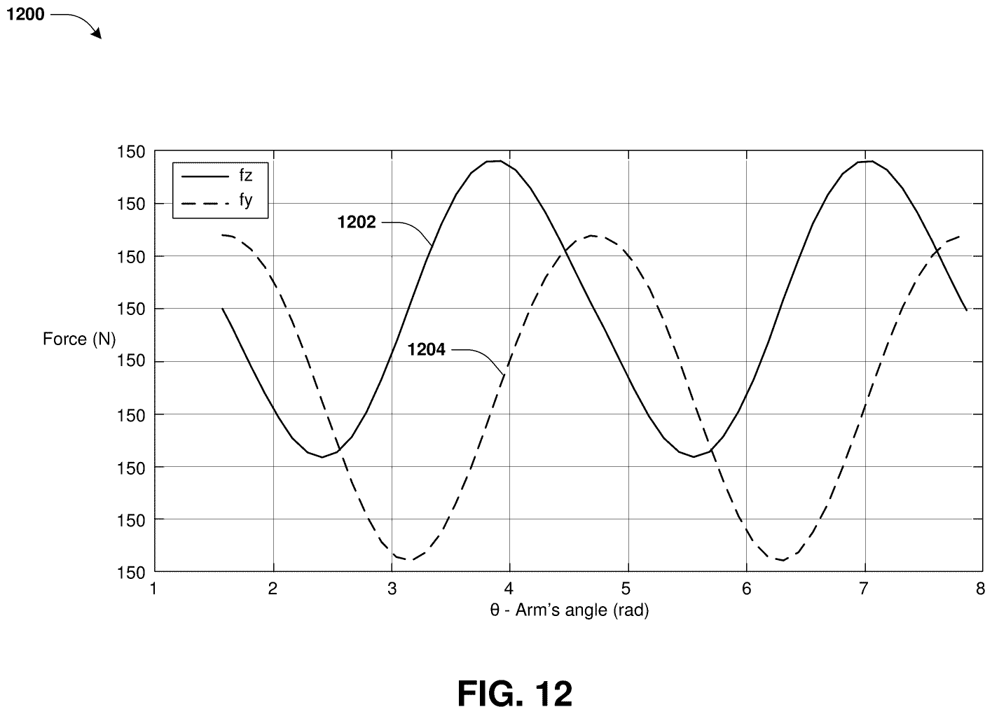

FIG. 12 illustrates a chart 1200 associated with forces produced by the fluid within one or more transfer pipes in the y-direction and the z-direction and generated based on the scenario 1000, in accordance with some embodiments. The chart 1200 comprises a first total force curve 1204 representative of a y-direction total force of the plurality of equal particles inside the one or more transfer pipes relative to the y-direction. The chart 1200 comprises a second total force curve 1202 representative of a z-direction total force of the plurality of equal particles inside the one or more transfer pipes relative to the z-direction. In some examples, the total force (in the y-direction and/or the z-direction, for example) depicted by the first total force curve 1204 and/or the second total force curve 1202 is produced when the rotating assembly performs a cycle of rotation in a time period (e.g., 2π rad (e.g., 360 degrees)) shown in the chart 1200 of FIG. 12). In an example, the y-direction average force f_{y}_{ₐᵥₑ} (e.g., the average force of the plurality of equal particles in the y-direction) and the z-direction average force f_{z}_{ₐᵥₑ} (e.g., the average force of the plurality of equal particles in the z-direction) in a cycle of rotation is determined as follows:

$${f}_{z a v e} = \frac{{\int }_{θ 1}^{θ 2} \overline{{f}_{z}} \times d θ}{{\int }_{θ 1}^{θ 2} d θ} , θ 1 = \frac{π}{2} , θ 2 = \frac{5 π}{2}$$

$${f}_{z a v e} = - 77 N , {f}_{y a v e} = - 0.0 \; 07 N$$

In some scenarios, the total force obtained from movement of the fluid inside the rotating assembly is determined. In some examples, the radius r is between about 10 mm to about 2000 mm (and/or between about 10 mm to about 1000 mm). For example, the radius r may be about 100 mm. Other values of the radius r, are within the scope of the present disclosure. In some examples, the angular velocity ω of the defined parameters is between about 1 rad/s to about 10000 rad/s (and/or about 10 rad/s to about 1000 rad/s). For example, the angular velocity ω may be about 100 rad/s. Other values of the angular velocity ω, are within the scope of the present disclosure. In some examples, the angular acceleration α is about zero. In some examples, the diameter d_{c} of the first cylinder 602 and the second cylinder 604 is between about 5 mm to about 100 mm (and/or between about 10 mm to about 50 mm). For example, the diameter de may be about 20 mm. Other values of the diameter d_{c} of the first cylinder 602 and the second cylinder 604, are within the scope of the present disclosure. In some examples, the diameter dₚ of the one or more transfer pipes between about 5 mm to about 100 mm (and/or between about 8 mm to about 50 mm). For example, the diameter dₚ may be about 10 mm. Other values of the diameter dₚ, are within the scope of the present disclosure. In some examples, the density ρ of the fluid is between about 100 kg/m³ to about 20000 kg/m³ (and/or between about 200 kg/m³ to about 15000 kg/m³). For example, the density of the fluid may be about 13500 kg/m³. Other values of the density ρ, are within the scope of the present disclosure. In some examples, the total force obtained from rotating of the fluid inside the rotating assembly f_{z}_{ₜₒₜ₁} equals the centrifugal force obtained from rotating the fluid inside the two or more cylinders f_{z}_{_{cyl}} plus the centrifugal force of the fluid inside the one or more transfer pipes f_{z}_{ₚᵢₚ₁}. In some examples, the total force (e.g., resultant force exerted on the one or more base plates) is determined as follows:

$${f}_{{z}_{cyl}} = 35.95 N$$

$${f}_{{z}_{pip 1}} = - 77 N$$

$${f}_{{z}_{tot 1}} = {f}_{{z}_{c y l}} + {f}_{{z}_{pip 1}} = 35.95 - 77$$

$${f}_{{z}_{tot 1}} ≅ - 41 N$$

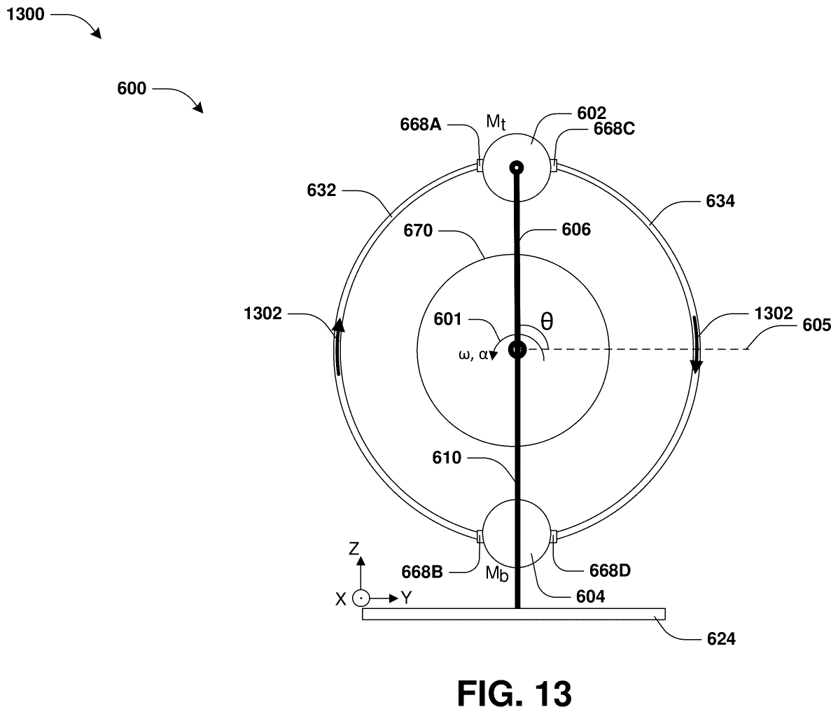

FIG. 13 illustrates a scenario 1300 associated with the propulsion apparatus 600 (shown with a cross-sectional view), in accordance with some embodiments. In FIG. 13, the propulsion apparatus 600 comprises the fluid (discussed herein with respect to FIGS. 6A-6C). Direction of a rotation 1302 of the fluid inside the one or more transfer pipes may be opposite to the direction of the first rotational direction 601 about the x-axis. In some examples, according to position of the one or more rotating arms at one or more times during a cycle of rotation (e.g., every moment of the cycle of rotation) as the rotating assembly rotates, the second transfer pipe 634 of the one or more transfer pipes may have the fluid flow (e.g., with the direction of a rotation 1302 of the fluid). In some examples, according to position of the one or more rotating arms at one or more times during a cycle of rotation (e.g., every moment of the cycle of rotation) as the rotating assembly rotates, the first transfer pipe 632 of the one or more transfer pipes may have the fluid flow (e.g., with the direction of a rotation 1302 of the fluid). In some examples, in the propulsion apparatus 600, when the first piston 614 and the third piston 626 move towards the geometric center of the first cylinder 602, the second piston 628 and the fourth piston 630 move away from the geometric center of the second cylinder 604. According to the movement of the two or more pistons, the third valve 668C may allow the fluid inside the first cylinder 602 to enter the second transfer pipe 634, and the fourth valve 668D may allow the fluid inside the second transfer pipe 634 to enter the second cylinder 604. In some examples, when the second piston 628 and the fourth piston 630 move towards the geometric center of the second cylinder 604, the first piston 614 and the third piston 626 move away from the geometric center of the first cylinder 602. According to the movement of the two or more pistons, the second valve 668B may allow the fluid inside the second cylinder 604 to enter the first transfer pipe 632, and the first valve 668A may allow the fluid inside the first transfer pipe 632 to enter the first cylinder 602.

In some examples, absolute angular velocity ω_{abs} of the fluid equals the angular velocity ω of the one or more transfer pipes minus the relative angular velocity ωᵣ of the fluid inside the one or more transfer pipes. Alternatively and/or additionally, absolute angular acceleration α_{abs} of the fluid equals the angular acceleration α of the one or more transfer pipes minus the relative angular acceleration αᵣ of the fluid inside the one or more transfer pipes. The absolute angular velocity ω_{abs} and the absolute angular acceleration α_{abs} of the fluid may be determined as follows:

$${ω}_{a b s} = ω - {ω}_{r}$$

$${α}_{a b s} = α - {α}_{r}$$

In an example, when there is no fluid flow (and/or less than a threshold amount of fluid flow) inside the one or more transfer pipes (e.g., the valves prevent the fluid from flowing through the one or more transfer pipes), the value of the relative angular velocity ωᵣ and the relative angular acceleration αᵣ of the fluid may be about zero, and thus, the absolute angular velocity ω_{abs} and the absolute angular acceleration α_{abs} of the fluid may be determined as follows:

ω_{abs}=ω

α_{abs}=α

In some examples, in the scenario 1300, tangential acceleration aₜ and normal acceleration aₙ of each particle of the plurality of equal particles are determined (e.g., calculated) using one, some and/or all of the techniques provided herein with respect to the scenario 1100. For example, at least some equations provided herein with respect to the scenario 1100 may be applicable to (and/or used to determine) tangential acceleration aₜ and normal acceleration aₙ of a particle in the scenario 1300.

In some examples, calculation of total mass M of the fluid inside the one or more transfer pipes and mass of each particle m of the plurality of equal particles of the scenario 1300 may be the same as (and/or similar to) calculation of total mass M of the fluid inside the one or more transfer pipes and mass of each particle m of the plurality of equal particles of the scenario 1100.

In some examples, calculation of the force of each particle of the plurality of equal particles exerted on the one or more base plates in the z-direction and the force of each particle of the plurality of equal particles exerted on the one or more base plates in the y-direction of the scenario 1300 is the same as (and/or similar to) calculation of the force of each particle of the plurality of equal particles exerted on the one or more base plates in the z-direction and the force of each particle of the plurality of equal particles exerted on the one or more base plates in the y-direction of the scenario 1100.

In some examples, calculation of the y-direction total force f̅_{y} and the z-direction total force f̅_{z} obtained from rotating the plurality of equal particles inside the one or more transfer pipes may be determined in the entire range of the first rotation angle θ (e.g., from about π/2 rad to about 5π/2 rad (e.g., 90≤θ≤450)) of the scenario 1300 is the same as (and/or similar to) calculation of the y-direction total force f̅_{y} and the z-direction total force f̅_{z} obtained from rotating the plurality of equal particles inside the one or more transfer pipes may be determined in the entire range of the first rotation angle θ (e.g., from about π/2 rad to about 5π/2 rad (e.g., 90≤θ≤450)) of the scenario 1100.

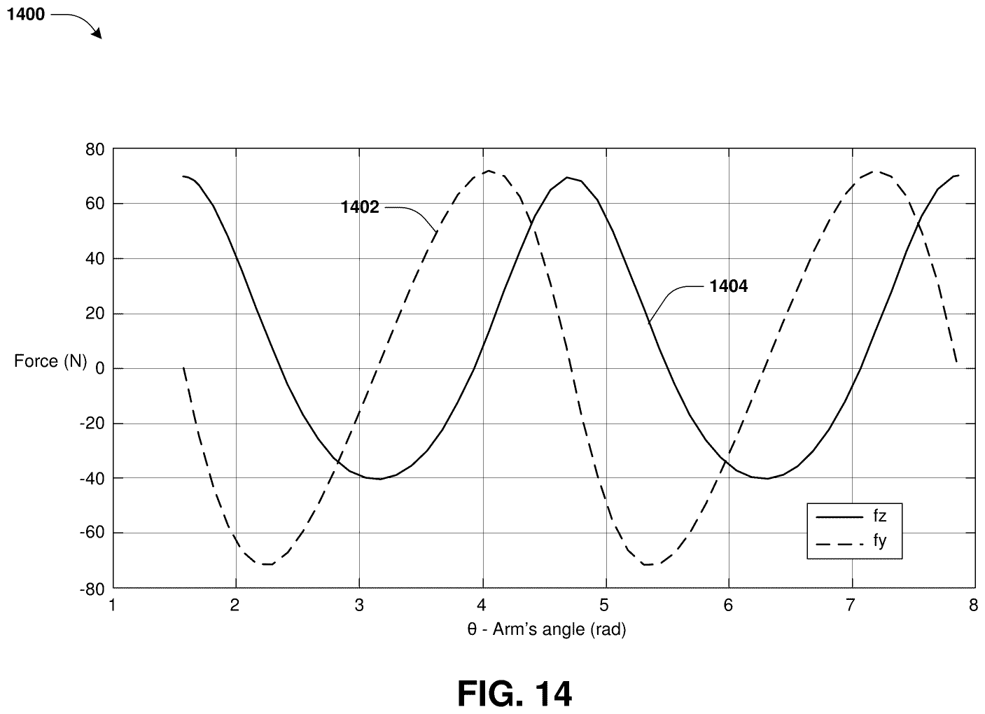

FIG. 14 illustrates a chart 1400 associated with forces produced by the fluid within one or more transfer pipes in the y-direction and the z-direction and generated based on the scenario 1300, in accordance with some embodiments. The chart 1400 comprises a first total force curve 1402 representative of a y-direction total force of the plurality of equal particles inside the one or more transfer pipes relative to the y-direction. The chart 1400 comprises a second total force curve 1404 representative of a z-direction total force of the plurality of equal particles inside the one or more transfer pipes relative to the z-direction. In some examples, the total force (in the y-direction and/or the z-direction, for example) depicted by the first total force curve 1402 and/or the second total force curve 1404 is produced when the rotating assembly performs a cycle of rotation in a time period (e.g., 2π rad) shown in the chart 1400 of FIG. 14). In an example, the y-direction average force f_{y}_{ₐᵥₑ} (e.g., the average force of the plurality of equal particles in the y-direction) and the z-direction average force f_{z}_{ₐᵥₑ} (e.g., the average force of the plurality of equal particles in the z-direction) in a cycle of rotation is determined as follows:

$${f}_{z a v e} = \frac{{\int }_{θ 1}^{θ 2} \overline{{f}_{z}} \times d θ}{{\int }_{θ 1}^{θ 2} d θ} , θ 1 = \frac{π}{2} , θ 2 = \frac{5 π}{2}$$

$${f}_{z a v e} = 7.3 N , {f}_{y a v e} = - 0.0 \; 03 N$$

In some scenarios, the total force obtained from movement of the fluid inside the rotating assembly is determined. In some examples, the radius r is between about 10 mm to about 2000 mm (and/or between about 10 mm to about 1000 mm). For example, the radius r may be about 100 mm. Other values of the radius r, are within the scope of the present disclosure. In some examples, the angular velocity ω of the defined parameters is between about 1 rad/s to about 10000 rad/s (and/or about 10 rad/s to about 1000 rad/s). For example, the angular velocity ω may be about 100 rad/s. Other values of the angular velocity ω, are within the scope of the present disclosure. In some examples, the angular acceleration α is about zero. Other values of the angular acceleration α, are within the scope of the present disclosure. In some examples, the diameter d_{c} of the first cylinder 602 and the second cylinder 604 is between about 5 mm to about 100 mm (and/or between about 10 mm to about 50 mm). For example, the diameter de may be about 20 mm. Other values of the diameter d_{c} of the first cylinder 602 and the second cylinder 604, are within the scope of the present disclosure. In some examples, the diameter dₚ of the one or more transfer pipes between about 5 mm to about 100 mm (and/or between about 8 mm to about 50 mm). For example, the diameter dₚ may be about 10 mm. Other values of the diameter dₚ, are within the scope of the present disclosure. In some examples, the density ρ of the fluid is between about 100 kg/m³ to about 20000 kg/m³ (and/or between about 200 kg/m³ to about 15000 kg/m³). For example, the density of the fluid may be about 13500 k/m³. Other values of the density ρ, are within the scope of the present disclosure. In some examples, the total force obtained from rotating of the fluid inside the rotating assembly f_{z}_{ₜₒₜ₂} equals the centrifugal force obtained from rotating the fluid inside the two or more cylinders f_{z}_{_{cyl}} plus the centrifugal force of the fluid inside the one or more transfer pipes f_{z}_{ₚᵢₚ₂}. The total force (e.g., resultant force exerted on the one or more base plates) may be determined as follows:

$${f}_{{z}_{c y l}} = 35.95 N$$

$${f}_{{z}_{pip 2}} = 7.3 N$$

$${f}_{{z}_{tot 2}} = {f}_{{z}_{c y l}} + {f}_{{z}_{pip 2}} = 35.95 + 7.3$$

$${f}_{{z}_{tot 2}} ≅ 43 N$$

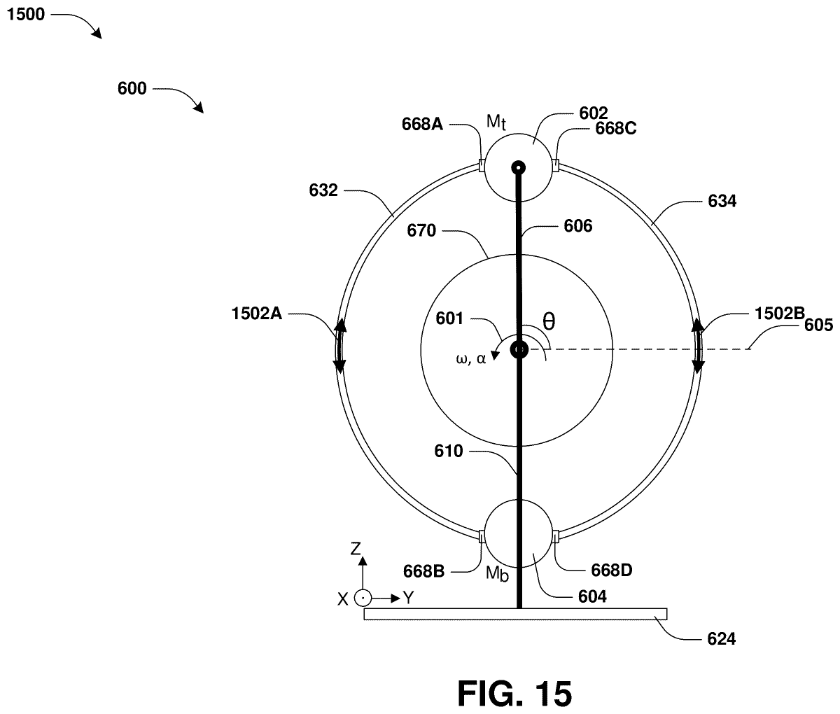

FIG. 15 illustrates a scenario 1500 associated with the propulsion apparatus 600 (shown with a cross-sectional view), in accordance with some embodiments. In FIG. 15, the propulsion apparatus 600 comprises the fluid (discussed herein with respect to FIGS. 6A-6C). Direction of a rotation 1502A of the fluid inside the first transfer pipe 632 of the one or more transfer pipes may be the same as (and/or similar to) the direction of the first rotational direction 601 about the x-axis and direction of a rotation 1502B of the fluid inside the second transfer pipe 634 of the one or more transfer pipes may be opposite to the direction of the first rotational direction 601 about the x-axis. In an example, direction of the rotation 1502A of the fluid inside the first transfer pipe 632 of the one or more transfer pipes is opposite to the direction of the first rotational direction 601 about the x-axis and direction of the rotation 1502B of the fluid inside the second transfer pipe 634 of the one or more transfer pipes is the same as (and/or similar to) the direction of the first rotational direction 601 about the x-axis. In an example, when the first piston 614 and the third piston 626 move towards the geometric center of the first cylinder 602, the second piston 628 and the fourth piston 630 move away from the geometric center of the second cylinder 604. In an example, according to the movement of the two or more pistons, the first valve 668A and the third valve 668C allows the fluid inside the first cylinder 602 to enter the first transfer pipe 632 and the second transfer pipe 634, while the second valve 668B and the fourth valve 668D allows the fluid inside the first transfer pipe 632 and the second transfer pipe 634 to enter the second cylinder 604. In an example, when the second piston 628 and the fourth piston 630 move towards the geometric center of the second cylinder 604, the first piston 614 and the third piston 626 move away from the geometric center of the first cylinder 602. In an example, according to the movement of the two or more pistons, the second valve 668B and the fourth valve 668D allows the fluid inside the second cylinder 604 to enter the first transfer pipe 632 and the second transfer pipe 634, while the first valve 668A and the third valve 668C allows the fluid inside the first transfer pipe 632 and the second transfer pipe 634 to enter the first cylinder 602.

In an example, when the direction of the rotation 1502A is the same as (and/or similar to) the direction of the first rotational direction 601 about the x-axis, the absolute angular velocity ω_{abs} of the fluid equals the angular velocity ω of the first transfer pipe 632 plus the relative angular velocity ωᵣ of the fluid inside the one or more transfer pipes and the absolute angular acceleration α_{abs} of the fluid equals the angular acceleration α of the one or more transfer pipes plus the relative angular acceleration αᵣ of the fluid inside the one or more transfer pipes. The absolute angular velocity ω_{abs} and the absolute angular acceleration α_{abs} may be determined as follows:

$${ω}_{a b s} = ω + {ω}_{r 3}$$

$${α}_{a b s} = α + {α}_{r 3}$$

In an example, when the direction of the rotation 1502B is opposite to the direction of the first rotational direction 601 about the x-axis, the absolute angular velocity ω_{abs} of the fluid equals the angular velocity ω of the second transfer pipe 634 minus the relative angular velocity ωᵣ of the fluid inside the one or more transfer pipes and the absolute angular acceleration α_{abs} of the fluid equals the angular acceleration α of the one or more transfer pipes minus the relative angular acceleration αᵣ of the fluid inside the one or more transfer pipes. The absolute angular velocity ω_{abs} and the absolute angular acceleration α_{abs} may be determined as follows:

$${ω}_{a b s} = ω - {ω}_{r 3}$$

$${α}_{a b s} = α - {α}_{r 3}$$

In some examples, due to unloading the fluid from the first cylinder 602 via the first valve 668A and the third valve 668C and conducting the fluid to the second cylinder 604 via the second valve 668B and the fourth valve 668D, the angular velocity ωᵣ₃ of the fluid in the scenario 1500 is reduced by about half in comparison with the angular velocities ωᵣ in the scenarios 1000 and 1300. The angular velocity ωᵣ₃ and the angular acceleration αᵣ₃ of the fluid in the scenario 1500, may be determined as follows:

$${ω}_{r 3} = \frac{1}{2} {ω}_{r} , {α}_{r 3} = \frac{1}{2} {α}_{r}$$

In some examples, calculation of tangential acceleration aₜ and normal acceleration aₙ of each particle of the plurality of equal particles of the scenario 1500 is the same as (and/or similar to) calculation of tangential acceleration aₜ and normal acceleration aₙ of each particle of the plurality of equal particles of the scenario 1100.

In some examples, calculation of total mass M of the fluid inside the one or more transfer pipes and mass of each particle m of the plurality of equal particles of the scenario 1500 is the same as (and/or similar to) calculation of total mass M of the fluid inside the one or more transfer pipes and mass of each particle m of the plurality of equal particles of the scenario 1100.

In some examples, calculation of the force of each particle of the plurality of equal particles exerted on the one or more base plates in the z-direction and the force of each particle of the plurality of equal particles exerted on the one or more base plates in the y-direction of the scenario 1500 is the same as (and/or similar to) calculation of the force of each particle of the plurality of equal particles exerted on the one or more base plates in the z-direction and the force of each particle of the plurality of equal particles exerted on the one or more base plates in the y-direction of the scenario 1100.

In some examples, calculation of the y-direction total force f̅_{y} and the z-direction total force f̅_{z} obtained from rotating the plurality of equal particles inside the one or more transfer pipes may be determined in the entire range of the first rotation angle θ (e.g., from about π/2 rad to about 5π/2 rad (e.g., 90≤θ≤450)) of the scenario 1500 is the same as (and/or similar to) calculation of the z-direction total force f̅_{z} and the y-direction total force f̅_{y} obtained from rotating the plurality of equal particles inside the one or more transfer pipes may be determined in the entire range of the first rotation angle θ (e.g., from about π/2 rad to about 5π/2 rad (e.g., 90≤θ≤450)) of the scenario 1100.

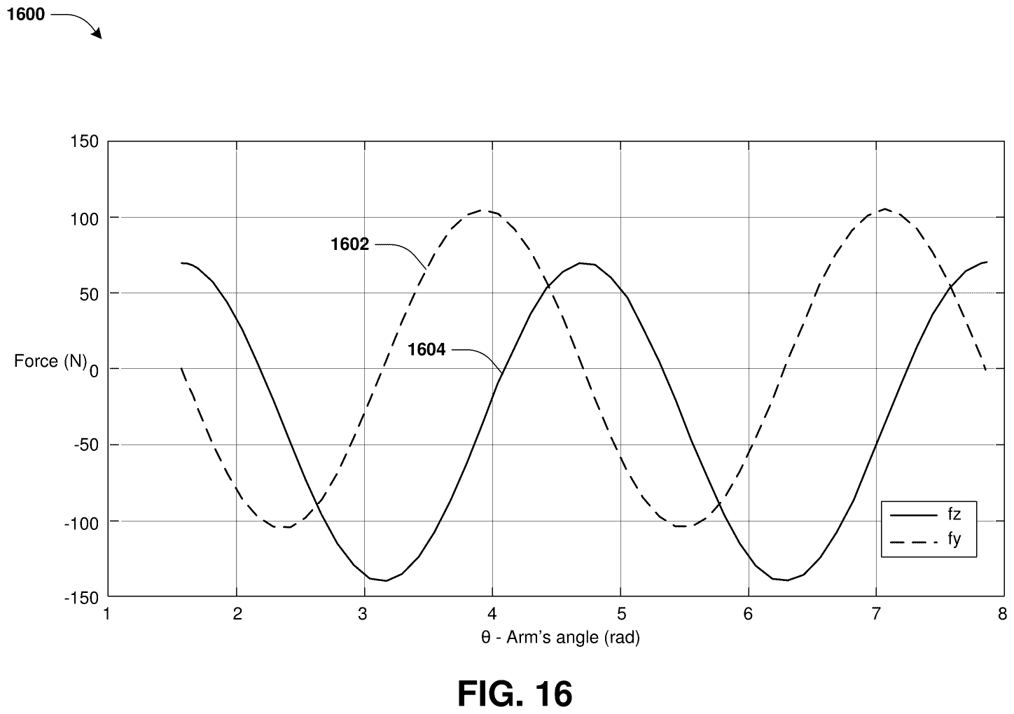

FIG. 16 illustrates a chart 1600 associated with forces produced by the fluid within one or more transfer pipes in the y-direction and the z-direction and generated based on the scenario 1500, in accordance with some embodiments. The chart 1600 comprises a first total force curve 1602 representative of a y-direction total force of the plurality of equal particles inside the one or more transfer pipes relative to the y-direction. The chart 1600 comprises a second total force curve 1604 representative of a z-direction total force of the plurality of equal particles inside the one or more transfer pipes relative to the z-direction. In some examples, the total force (in the y-direction and/or the z-direction, for example) depicted by the first total force curve 1602 and/or the second total force curve 1604 is produced when the rotating assembly performs a cycle of rotation in a time period (e.g., 2π rad (e.g., 360 degrees) shown in the chart 1600 of FIG. 16). In an example, the y-direction average force f_{y}_{ₐᵥₑ} (e.g., the average force of the plurality of equal particles in the y-direction) and the z-direction average force f_{z}_{ₐᵥₑ} (e.g., the average force of the plurality of equal particles in the z-direction) in a cycle of rotation are determined as follows:

$${f}_{z a v e} = \frac{{\int }_{θ 1}^{θ 2} \overline{{f}_{z}} \times d θ}{{\int }_{θ 1}^{θ 2} d θ} , θ 1 = \frac{π}{2} , θ 2 = \frac{5 π}{2}$$

$${f}_{z a v e} = - 3 4.9 N , {f}_{y a v e} = - 0.0 \; 05 N$$

In some examples, the total force obtained from movement of the fluid inside the rotating assembly is determined. In some examples, the radius r is between about 10 mm to about 2000 mm (and/or between about 10 mm to about 1000 mm). For example, the radius r may be about 100 mm. Other values of the radius r, are within the scope of the present disclosure. In some examples, the angular velocity ω of the defined parameters is between about 1 rad/s to about 10000 rad/s (and/or about 10 rad/s to about 1000 rad/s). For example, the angular velocity ω may be about 100 rad/s. Other values of the angular velocity ω, are within the scope of the present disclosure. In some examples, the angular acceleration α is about zero. Other values of the angular acceleration α, are within the scope of the present disclosure. In some examples, the diameter d_{c} of the first cylinder 602 and the second cylinder 604 is between about 5 mm to about 100 mm (and/or between about 10 mm to about 50 mm). For example, the diameter de may be about 20 mm. Other values of the diameter d_{c} of the first cylinder 602 and the second cylinder 604, are within the scope of the present disclosure. In some examples, the diameter dₚ of the one or more transfer pipes between about 5 mm to about 100 mm (and/or between about 8 mm to about 50 mm). For example, the diameter dₚ may be about 10 mm. Other values of the diameter dₚ, are within the scope of the present disclosure. In some examples, the density ρ of the fluid is between about 100 kg/m³ to about 20000 kg/m³ (and/or between about 200 kg/m³ to about 15000 kg/m³). For example, the density of the fluid may be about 13500 k/m³. Other values of the density ρ, are within the scope of the present disclosure. In some examples, the total force obtained from rotating of the fluid inside the rotating assembly f_{z}_{ₜₒₜ₃} equals the centrifugal force obtained from rotating the fluid inside the two or more cylinders f_{z}_{_{cyl}} plus the centrifugal force of the fluid inside the one or more transfer pipes f_{z}_{ₚᵢₚ₃}. The total force (e.g., resultant force exerted on the one or more base plates) may be determined as follows:

$${f}_{{z}_{cyl}} = 35.95 N$$

$${f}_{{z}_{pip 3}} = - 3 4.9 N$$

$${f}_{{z}_{tot 3}} = {f}_{{z}_{c y l}} + {f}_{{z}_{pip 3}} = 35.95 - 34.9$$

$${f}_{{z}_{tot 3}} ≅ 1 N$$

In some examples, the amount of total force (e.g., resultant force exerted on the one or more base plates) obtained based on the scenario 1300 is greater than the amount of total force (e.g., resultant force exerted on the one or more base plates) obtained based on the scenario 1000 and the scenario 1500. In some examples, the amount of total force (e.g., resultant force exerted on the one or more base plates) obtained based on the scenario 1000 is greater than the amount of total force (e.g., resultant force exerted on the one or more base plates) obtained based on the scenario 1500.

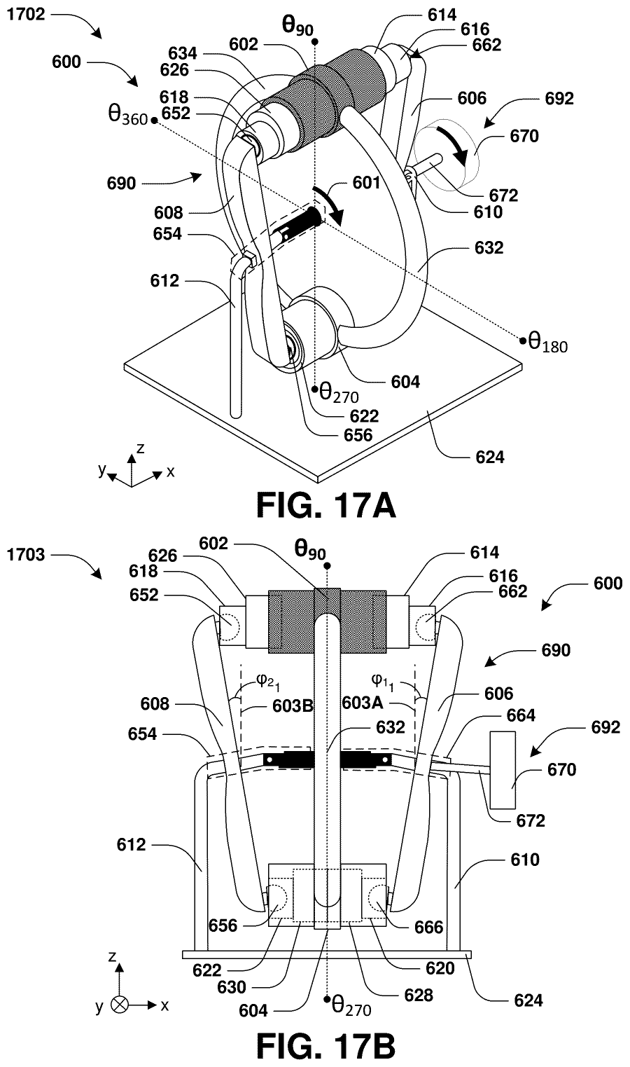

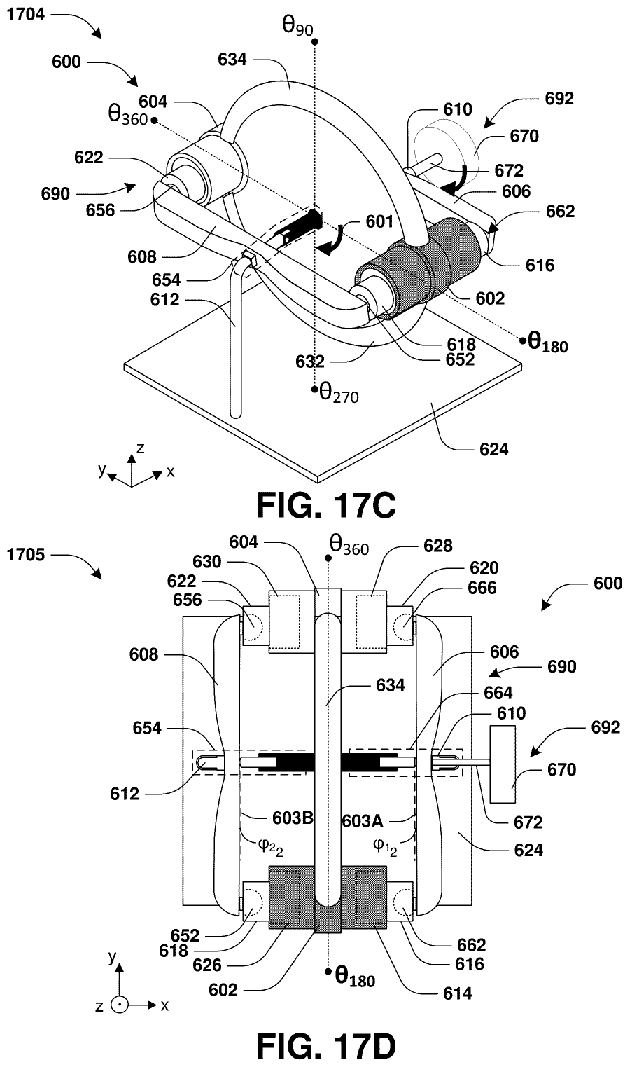

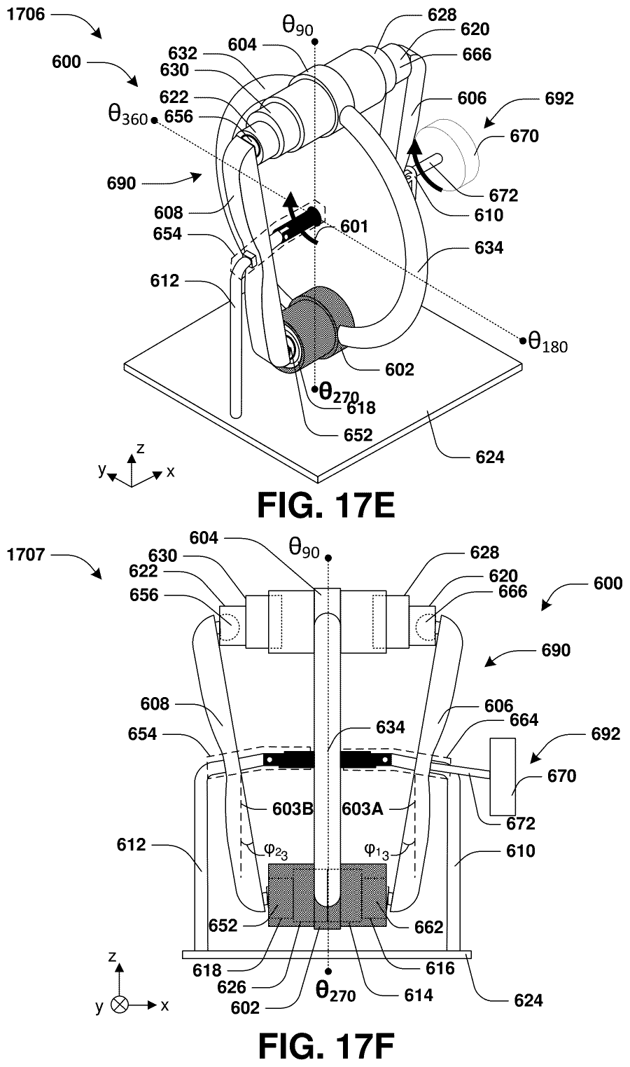

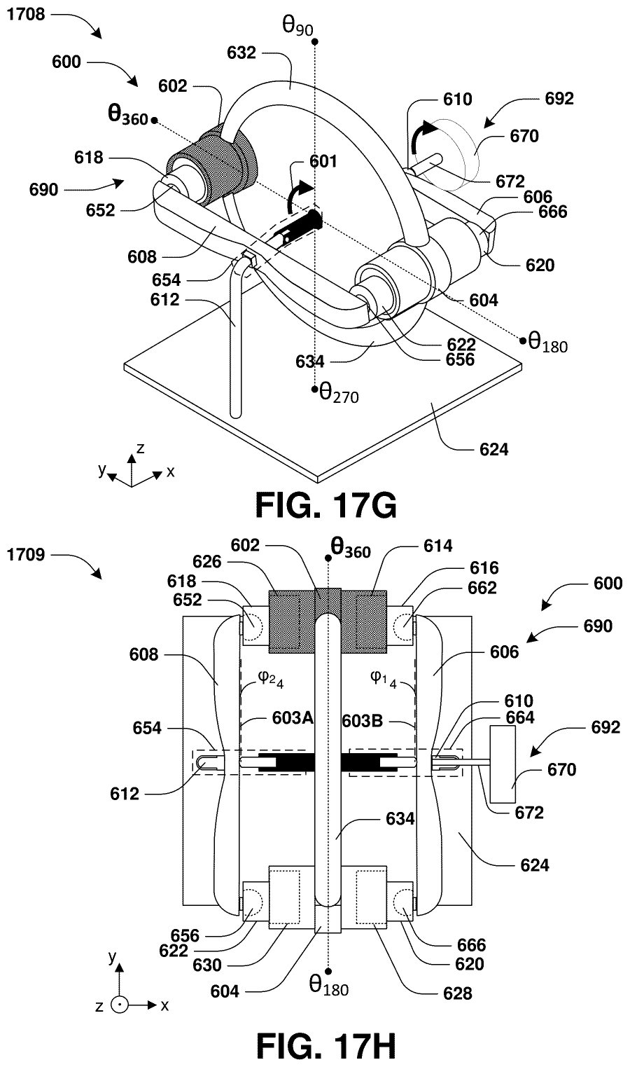

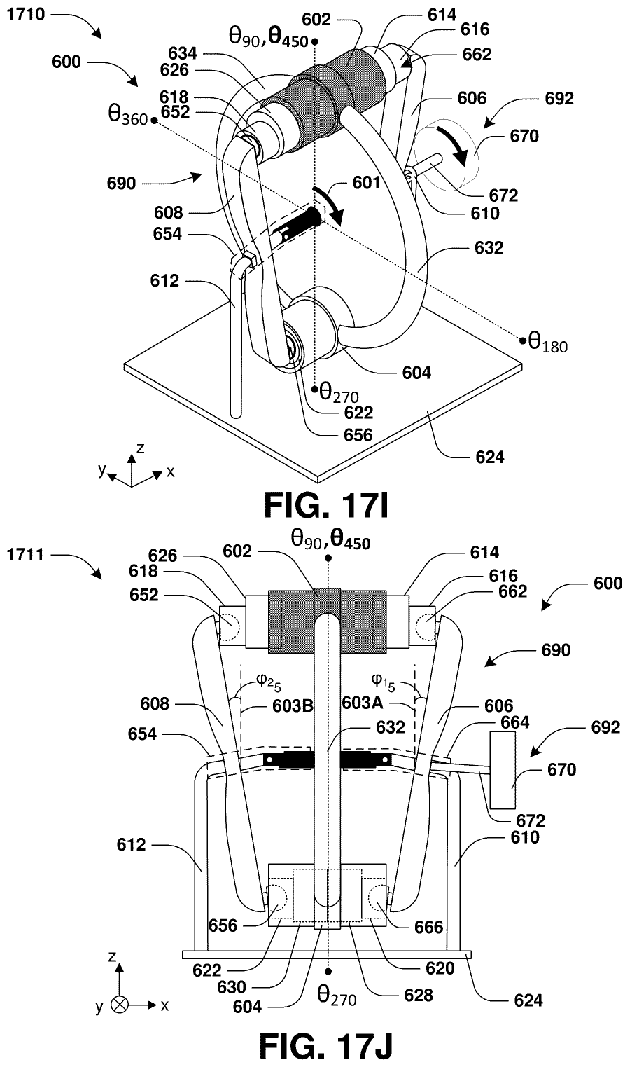

FIG. 17A illustrates a perspective view 1702 of the propulsion apparatus 600 in a first state of operation, in accordance with some embodiments. FIG. 17B illustrates a front view 1703 of the propulsion apparatus 600 in the first state of operation, in accordance with some embodiments. FIG. 17C illustrates a perspective view 1704 of the propulsion apparatus 600 in a second state of operation, in accordance with some embodiments. FIG. 17D illustrates a top view 1705 of the propulsion apparatus 600 in the second state of operation, in accordance with some embodiments. FIG. 17E illustrates a perspective view 1706 of the propulsion apparatus 600 in a third state of operation, in accordance with some embodiments. FIG. 17F illustrates a front view 1707 of the propulsion apparatus 600 in the third state of operation, in accordance with some embodiments. FIG. 17G illustrates a perspective view 1708 of the propulsion apparatus 600 in a fourth state of operation, in accordance with some embodiments. FIG. 17H illustrates a top view 1709 of the propulsion apparatus 600 in the fourth state of operation, in accordance with some embodiments. FIG. 17I illustrates a perspective view 1710 of the propulsion apparatus 600 in a fifth state of operation, in accordance with some embodiments. FIG. 17J illustrates a front view 1711 of the propulsion apparatus 600 in the fifth state of operation, in accordance with some embodiments. In some examples, the first state of operation may be an initial state (e.g., when the propulsion apparatus 600 starts to work and/or when the first cylinder 602 is positioned on the first point θ₉₀) of operation associated with the propulsion apparatus 600. In an example, the second state of operation may be when the first cylinder 602 is positioned on the second point θ₁₈₀. In an example, the third state of operation may be when the first cylinder 602 is positioned on the third point θ₂₇₀. In an example, the fourth state of operation may be when the first cylinder 602 is positioned on the fourth point θ₃₆₀. In an example, the fifth state of operation may be when the first cylinder 602 is positioned on the fifth point θ₄₅₀. FIGS. 17A-17B provide a representation 1702 of the propulsion device 690 when (i) the first rotation angle θ may be about π/2 rad (e.g., 90 degrees) (ii) the second rotation angle φ₁ may be about 10 degrees, and (iii) the third rotation angle φ₂ may be about −10 degrees. FIGS. 17C-17D provide a representation 1704 of the propulsion apparatus 600 when (i) the first rotation angle θ may be about π rad (e.g., 180 degrees) (ii) the second rotation angle φ₁ may be about 0 degrees, and (iii) the third rotation angle φ₂ may be about 0 degrees. FIGS. 17E-17F provide a representation 1706 of the propulsion apparatus 600 when (i) the first rotation angle θ may be about 3π/2 rad (e.g., 270 degrees) (ii) the second rotation angle φ₁ may be about −10 degrees, and (iii) the third rotation angle φ₂ may be about 10 degrees. FIGS. 17G-17H provide a representation 1708 of the propulsion apparatus 600 when (i) the first rotation angle θ may be about 2π rad (e.g., 360 degrees) (ii) the second rotation angle φ₁ may be about 0 degrees, and (iii) the third rotation angle φ₂ may be about 0 degrees. FIGS. 17I-17J provide a representation 1710 of the propulsion apparatus 600 when (i) the first rotation angle θ may be about 5π/2 rad (e.g., 450 degrees) (ii) the second rotation angle φ₁ may be about 10 degrees, and (iii) the third rotation angle φ₂ may be about −10 degrees. Other values of the first rotation angle θ, the second rotation angle φ₁ and the third rotation angle φ₂ are within the scope of the present disclosure.

In some embodiments, concentrating the direction of centrifugal forces of the rotating assembly in the form of the propulsion apparatus 600 may provide the ability to fully control the direction of the force output from the propulsion apparatus 600.

In some embodiments, the propulsion apparatus 600 operates in a first environment. The first environment may be in space (e.g., outside Earth's atmosphere). Alternatively and/or additionally, the first environment may be on Earth's surface and/or within Earth's atmosphere (e.g., in the air). Alternatively and/or additionally, the first environment may be in a body of water (e.g., an ocean, a lake, a pond, a pool, etc.).

Thus, in accordance with some embodiments, the propulsion apparatus 600 may produce an adjustable (e.g., controllable) force in one or more adjustable (e.g., controllable) directions (without requiring a certain type of environment and/or without requiring surface contact and/or friction, for example). The propulsion apparatus 600 may be used in a transportation system (for land transportation, air transportation, transportation through a body of water, space transportation, etc.), vehicle brake systems, stability control system, and/or other applications (e.g., industrial applications. For example, the propulsion apparatus 600 may be used to transport an object coupled to (and/or carried by) the propulsion apparatus 600 from a first location to a second location through at least one of space, land, air, a body of water, etc.

Other configurations, dimensions, interrelationships between elements, etc. of the propulsion apparatus 600 other than those discussed in the specification and/or shown in the annexed drawings are within the scope of the present disclosure.

In some embodiments, a propulsion apparatus is provided. The propulsion apparatus includes a power generation unit. The propulsion apparatus includes a propulsion device. The propulsion device includes a rotating assembly. The rotating assembly includes two or more pressurizer units. The rotating assembly includes one or more rotating arms connected to the two or more pressurizer units and a supporting mechanism. The rotating assembly includes one or more transfer pipes connected to the two or more pressurizer units to allow one or more materials to move between the two or more pressurizer units. The propulsion device includes the supporting mechanism which allows the rotating assembly to rotate about one or more rotating axes.

In some embodiments, the power generation unit applies a generated power to rotate the rotating assembly about the one or more rotation axes.

In some embodiments, the supporting mechanism includes one or more holding rods. The one or more holding rods includes a first holding rod of the connected to a first rotating arm of the one or more rotating arms. The one or more holding rods includes a second holding rod of the one or more holding rods connected to a second rotating arm of the one or more rotating arms. The support mechanism includes one or more base plates which connect the one or more holding rods to the one or more walls of the non-contacting propulsion device.

In some embodiments, the supporting mechanism includes a first joint connecting the first holding rod of the supporting mechanism to the first rotating arm of the one or more rotating arms. The supporting mechanism includes a second joint connecting the second holding rod of the supporting mechanism to the second rotating arm of the one or more rotating arms.

In some embodiments, the first joint includes at least one of a first pivot or a first hinge. The second joint includes at least one of a second pivot or a second hinge.

In some embodiments, the two or more pressurizer units includes two or more pistons connected to two or more piston connecting rods. A first side of a first piston connecting rod of the two or more piston connecting rods is connected to a first piston of the two or more pistons. A second side of the first piston connecting rod is connected to a first rotating arm of the one or more rotating arms. The two or more pressurizer units includes a first cylinder configure to at least partially house the first piston. The first piston moves in the first cylinder.

In some embodiments, a first side of a second piston connecting rod of the two or more piston connecting rods is connected to a second piston of the two or more pistons. A second side of the second piston connecting rod is connected to the first rotating arm of the one or more rotating arms. The propulsion device includes a third joint connecting the second side of the first piston connecting rod to the first rotating arm of the one or more rotating arms. The third joint allows the first piston to move in the first cylinder, a fourth joint connecting the second side of the second piston connecting rod to the first rotating arm. The fourth joint allows the second piston to move in a second cylinder is configured to at least partially house the second piston, and a first joint connecting a first holding rod of the supporting mechanism to the first rotating arm.

In some embodiments, the third joint includes at least of a third pivot or a third hinge. The fourth joint includes at least one of a fourth pivot or a fourth hinge. The first joint includes at least one of a first pivot or a first hinge.

In some embodiments, the first joint allows the rotating arm to rotate about a first rotation axis with a first angular velocity and a first angular acceleration. The first joint allows the first rotating arm to rotate about a second rotation axes with a second angular velocity and a second angular acceleration.

In some embodiments, the first angular velocity is different than the second angular velocity or the first angular acceleration is different than the second angular acceleration.

In some embodiments, the first cylinder is configured to at least partially house the first piston in a first section of the first cylinder. The first piston moves in the first section of the first cylinder. The first cylinder is configured to at least partially house a third piston in a second section of the first cylinder. The second cylinder is configured to at least partially house the second piston in a first section of the second cylinder. The second piston moves in the first section of the second cylinder. The second cylinder is configured to at least partially house a fourth piston in a second section of the second cylinder. The fourth piston moves in the second section of the second cylinder.

In some embodiments, the two or more pressurizer units includes the two or more pistons connected to the two or more piston connecting rods. a first side of the third piston connecting rod of the two or more piston connecting rods is connected to the third piston of the two or more pistons, and a second side of the third piston connecting rod is connected to a second rotating arm of the one or more rotating arms, and the first cylinder is configured to at least partially house the third piston. The third piston moves in the first cylinder.

In some embodiments, a first side of the fourth piston connecting rod of the two or more piston connecting rods is connected to the fourth piston of the two or more pistons. A second side of the fourth piston connecting rod is connected to the second rotating arm of the one or more rotating arms. The propulsion device includes a fifth joint connecting the second side of the third piston connecting rod to the second rotating arm of the one or more rotating arms. The fifth joint allows the third piston to move in the first cylinder, a sixth joint connecting the second side of the fourth piston connecting rod to the second rotating arm. The sixth joint allows the fourth piston to move in the second cylinder is configured to at least partially house the fourth piston, and a second joint connecting a second holding rod of the supporting mechanism to the second rotating arm.

In some embodiments, the fifth joint includes at least one of a fifth pivot or a fifth hinge. The sixth joint includes at least one of a sixth pivot or a sixth hinge. The second joint includes at least one of a second pivot or a second hinge.

In some embodiments, the second joint allows the second rotating arm to rotate about a first rotation axis with a first angular velocity and a first angular acceleration. The second joint allows the second rotating arm to rotate about a second rotation axis with a second angular velocity and a second angular acceleration.

In some embodiments, the first angular velocity is different than the second angular velocity and/or the first angular acceleration is different than the second angular acceleration.

In some embodiments, the one or more materials includes a gas, a liquid, a solid and/or a plasma.

In some embodiments, the propulsion apparatus is a non-contacting propulsion apparatus, the propulsion apparatus transforms a centrifugal force obtained from the rotation of the rotating assembly about the one or more rotation axes to an adjustable force, the propulsion device is a non-contacting propulsion device, the one or more transfer pipes are connected to the two or more pressurizer units via one or more valves and/or a cross-sectional shape of a transferring pipe of the one or more transfer pipes is at least one of circular, oval, triangular, square, rectangular, or polygonal.

In some examples, a propulsion apparatus is provided. In some examples, the propulsion apparatus includes a power generation unit, and a propulsion device. In some examples, the propulsion device includes a rotating assembly, and a supporting mechanism. In some examples, the rotating assembly includes a first pressurizer unit, a second pressurizer unit, one or more rotating arms connected to the first pressurizer unit, the second pressurizer unit and the supporting mechanism, and one or more transfer pipes connected to the first pressurizer unit and the second pressurizer unit to allow one or more materials to move between the first pressurizer unit and the second pressurizer unit. In some examples, the supporting mechanism allows the rotating assembly to rotate about one or more rotation axes.

In some examples, the power generation unit applies a generated power to rotate the rotating assembly about the one or more rotation axes.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A propulsion apparatus, comprising:
a power generation unit; and
a propulsion device, comprising:
a rotating assembly, comprising:
two or more pressurizer units;
one or more rotating arms connected to the two or more pressurizer units and a supporting mechanism; and
one or more transfer pipes connected to the two or more pressurizer units to allow one or more materials to move between the two or more pressurizer units; and
the supporting mechanism which allows the rotating assembly to rotate about one or more rotation axes.

2. The propulsion apparatus of claim 1, wherein the power generation unit applies a generated power to rotate the rotating assembly about the one or more rotation axes.

3. The propulsion apparatus of claim 1, wherein the supporting mechanism comprises:
one or more holding rods wherein:
a first holding rod of the one or more holding rods is connected to a first rotating arm of the one or more rotating arms; and
a second holding rod of the one or more holding rods is connected to a second rotating arm of the one or more rotating arms; and
one or more base plates which connect the one or more holding rods to one or more walls of the propulsion device.

4. The propulsion apparatus of claim 3, wherein the supporting mechanism comprises:
a first joint connecting the first holding rod of the supporting mechanism to the first rotating arm of the one or more rotating arms; and
a second joint connecting the second holding rod of the supporting mechanism to the second rotating arm of the one or more rotating arms.

5. The propulsion apparatus of claim 4, wherein:
the first joint comprises at least one of a first pivot or a first hinge; and
the second joint comprises at least one of a second pivot or a second hinge.

6. The propulsion apparatus of claim 1, wherein the two or more pressurizer units comprise:
two or more pistons connected to two or more piston connecting rods wherein:
a first side of a first piston connecting rod of the two or more piston connecting rods is connected to a first piston of the two or more pistons; and
a second side of the first piston connecting rod is connected to a first rotating arm of the one or more rotating arms; and
a first cylinder configured to at least partially house the first piston, wherein the first piston moves in the first cylinder.

7. The propulsion apparatus of claim 6, wherein:
a first side of a second piston connecting rod of the two or more piston connecting rods is connected to a second piston of the two or more pistons;
a second side of the second piston connecting rod is connected to the first rotating arm of the one or more rotating arms; and
the propulsion device comprises:
a third joint connecting the second side of the first piston connecting rod to the first rotating arm of the one or more rotating arms, wherein the third joint allows the first piston to move in the first cylinder;
a fourth joint connecting the second side of the second piston connecting rod to the first rotating arm, wherein the fourth joint allows the second piston to move in a second cylinder configured to at least partially house the second piston; and
a first joint connecting a first holding rod of the supporting mechanism to the first rotating arm.

8. The propulsion apparatus of claim 7, wherein:
the third joint comprises at least one of a third pivot or a third hinge;
the fourth joint comprises at least one of a fourth pivot or a fourth hinge; and
the first joint comprises at least one of a first pivot or a first hinge.

9. The propulsion apparatus of claim 8, wherein the first joint allows the first rotating arm to:
rotate about a first rotation axis with a first angular velocity and a first angular acceleration; and
rotate about a second rotation axis with a second angular velocity and a second angular acceleration.

10. The propulsion apparatus of claim 9, wherein at least one of:
the first angular velocity is different than the second angular velocity; or
the first angular acceleration is different than the second angular acceleration.

11. The propulsion apparatus of claim 7, wherein:
the first cylinder configured to:
at least partially house the first piston in a first section of the first cylinder, wherein the first piston moves in the first section of the first cylinder; and
at least partially house a third piston in a second section of the first cylinder, wherein the third piston moves in the second section of the first cylinder; and
the second cylinder configured to:
at least partially house the second piston in a first section of the second cylinder, wherein the second piston moves in the first section of the second cylinder; and
at least partially house a fourth piston in a second section of the second cylinder, wherein the fourth piston moves in the second section of the second cylinder.

12. The propulsion apparatus of claim 11, wherein the two or more pressurizer units comprise:
the two or more pistons connected to the two or more piston connecting rods wherein:
a first side of the third piston connecting rod of the two or more piston connecting rods is connected to the third piston of the two or more pistons; and
a second side of the third piston connecting rod is connected to a second rotating arm of the one or more rotating arms; and
the first cylinder configured to at least partially house the third piston, wherein the third piston moves in the first cylinder.

13. The propulsion apparatus of claim 12, wherein:
a first side of the fourth piston connecting rod of the two or more piston connecting rods is connected to the fourth piston of the two or more pistons;
a second side of the fourth piston connecting rod is connected to the second rotating arm of the one or more rotating arms; and
the propulsion device comprises:
a fifth joint connecting the second side of the third piston connecting rod to the second rotating arm of the one or more rotating arms, wherein the fifth joint allows the third piston to move in the first cylinder;
a sixth joint connecting the second side of the fourth piston connecting rod to the second rotating arm, wherein the sixth joint allows the fourth piston to move in the second cylinder configured to at least partially house the fourth piston; and
a second joint connecting a second holding rod of the supporting mechanism to the second rotating arm.

14. The propulsion apparatus of claim 13, wherein:
the fifth joint comprises at least one of a fifth pivot or a fifth hinge;
the sixth joint comprises at least one of a sixth pivot or a sixth hinge; and
the second joint comprises at least one of a second pivot or a second hinge.

15. The propulsion apparatus of claim 13, wherein the second joint allows the second rotating arm to:
rotate about a first rotation axis with a first angular velocity and a first angular acceleration; and
rotate about a second rotation axis with a second angular velocity and a second angular acceleration.

16. The propulsion apparatus of claim 15, wherein at least one of:
the first angular velocity is different than the second angular velocity; or
the first angular acceleration is different than the second angular acceleration.

17. The propulsion apparatus of claim 1, wherein the one or more materials comprise at least one of:
a gas;
a liquid;
a solid; or
a plasma.

18. The propulsion apparatus of claim 1, wherein at least one of:
the propulsion apparatus is a non-contacting propulsion apparatus;
the propulsion apparatus transforms a centrifugal force obtained from the rotation of the rotating assembly about the one or more rotation axes to an adjustable force;
the one or more transfer pipes are connected to the two or more pressurizer units via one or more valves; or
a cross-sectional shape of a transferring pipe of the one or more transfer pipes is at least one of circular, oval, triangular, square, rectangular, or polygonal.

19. A propulsion apparatus, comprising:
a power generation unit; and
a propulsion device, comprising:
a rotating assembly, comprising:
a first pressurizer unit;
a second pressurizer unit;
one or more rotating arms connected to the first pressurizer unit, the second pressurizer unit and a supporting mechanism; and
one or more transfer pipes connected to the first pressurizer unit and the second pressurizer unit to allow one or more materials to move between the first pressurizer unit and the second pressurizer unit; and
the supporting mechanism which allows the rotating assembly to rotate about one or more rotation axes.

20. The propulsion apparatus of claim 19, wherein the power generation unit applies a generated power to rotate the rotating assembly about the one or more rotation axes.
